(19) United States
(12) Patent Application Publication
(10) Pub. No.: US 2023/0164774 A1
(43) Pub. Date: May 25, 2023

(54) PRIORITIZATION BETWEEN SR AND HARQ-ACK

(71) Applicant: TELEFONAKTIEBOLAGET LM ERICSSON (PUBL), STOCKHOLM (SE)

(72) Inventors: Jonas Fröberg Olsson, LJUNGSBRO (SE); Kittipong Kittichokechai, JÄRFÄLLA (SE); Yufei Blankenship, KILDEER, IL (US); Ali Behravan, STOCKHOLM (SE); Sorour Falahati, STOCKHOLM (SE)

(21) Appl. No.: 17/918,073

(22) PCT Filed: Apr. 12, 2021
(86) PCT No.: PCT/IB2021/053018

§ 371 Date: Oct. 10, 2022

Related U.S. Application Data
(60) Provisional application No. 63/008,419, filed on Apr. 10, 2020.

(51) Int. Cl. H04W 72/1268; H04L 1/1812; H04W 72/566

(52) U.S. Cl. CPC H04W 72/1268; H04L 1/1812; H04W 72/566

(57) ABSTRACT

Systems and methods are disclosed herein that relate to prioritization of Scheduling Requests (SRs) and Hybrid Automatic Repeat Request (HARQ) feedback information. In one embodiment, a method performed by a wireless communication device for prioritization between a Scheduling Request (SR) occasion and Hybrid Automatic Repeat Request Acknowledgment (HARQ-ACK) information scheduled on overlapping Physical Uplink Control Channel (PUCCH) resources comprising prioritizing or multiplexing a SR occasion on a first PUCCH resource and HARQ-ACK information on a second PUCCH resource, the first PUCCH resource and the second PUCCH resource at least partially overlapping in time. In this manner, latency improvement for uplink (UL) is provided without introducing higher downlink (DL) load nor inter-cell interference since unnecessary re-transmissions can be avoided.

### RELATED APPLICATIONS

This application claims the benefit of U.S. Provisional Patent Application No. 63/008,419, filed Apr. 10, 2020, the disclosure of which is hereby incorporated herein by reference in its entirety.

### TECHNICAL FIELD

The present disclosure relates to Scheduling Requests (SRs) and Hybrid Automatic Repeat Request (HARQ) feedback on the uplink in a cellular communications system.

### BACKGROUND

In New Radio (NR) Release 15, Uplink Control Information (UCI) consists of physical layer control information that can be Scheduling Request (SR), Hybrid Automatic Repeat Request Acknowledgment (HARQ-ACK) feedback in response to Physical Downlink Shared Channel (PDSCH) receptions, and Channel State Information (CSI). UCI can be sent on either Physical Uplink Control Channel (PUCCH) or on Physical Uplink Shared Channel (PUSCH) multiplexed with uplink (UL) data. On PUCCH, UCI is sent using one of four different PUCCH formats. PUCCH format 0 and PUCCH format 1 are used when the number of UCI bits is 1 or 2, which only happens when the UCI consists of HARQ-ACK and/or SR. The other formats are used when the number of UCI bits is more than two, which happen if CSI is included (with or without HARQ-ACK/SR) or if the number of HARQ-ACK bits is more than two (with or without SR). PUCCH format 0 and PUCCH format 2 are used for PUCCH transmissions over 1 or 2 symbols.

A SchedulingRequestResourceConfig is a resource configuration for opportunities for sending SR. The configuration consists of an identity pointing to a PUCCH resource and a periodicityAndOffset that determine time location and periodicity of the occasions for the SR transmission opportunities. The PUCCH resource identified is a specification of starting frequency location (startingPRB) for the resource but also which PUCCH format shall be used on the resource. For SR, the PUCCH format is either format 0 or format 1. All formats specify a time location within a slot using parameters startingSymbolIndex and nrofSymbols. PUCCH format 0, PUCCH format 1, and PUCCH format 4 use a single Physical Resource Block (PRB) in frequency domain while the other formats can be configured with multiple PRBs.

The User Equipment (UE) can be configured with multiple SR configurations, where each SR can be associated with a set of Logical Channels (LCHs), i.e. different SR can be associated with different services such as enhanced Mobile Broadband (eMBB) and Ultra-Reliable Low-Latency Communication (URLLC).

In Release 15, a UE can be configured with a maximum of four PUCCH resource sets, where each PUCCH resource set may consist of several PUCCH resources that can be used for a range of UCI sizes provided by configuration, including HARQ-ACK bits. The first set is only applicable for 1-2 UCI bits including HARQ-ACK information and can have a maximum of 32 PUCCH resources, while the other sets, if configured, are used for more than two UCI bits including HARQ-ACK and each can be realized using any one of up to a maximum of eight different PUCCH resources. When a UE reports HARQ-ACK on PUCCH, it determines a PUCCH resource set based on the number of HARQ-ACK information bits it has to send and the PUCCH resource indicator field in the last received Downlink Control Information (DCI) format 1_0 or DCI format 1_1 that has a value of PDSCH-to-HARQ feedback timing indicator indicating a slot for the PUCCH transmission that is the same as the slot associated with the next instance of one of the members of the PUCCH resource set. When the size of the determined PUCCH resource set is at most eight (3-bit PUCCH resource indicator field), the PUCCH resource identity within the set is explicitly indicated by the PUCCH resource indicator field in the DCI. If the size of PUCCH resource set is more than eight, the PUCCH resource identity is determined by the index of the first Control Channel Element (CCE) for the Physical Downlink Control Channel (PDCCH) reception in addition to the PUCCH resource indicator field in the DCI.

When there are multiple types of UCI and the UE may have PUCCH resources for PUCCH transmissions of UCI that overlap in time, the UE resolves the time overlap using a specified resolution procedure. The result of this procedure is PUCCH resources that do not overlap in time and where each carry UCI. Different UCI types can be multiplexed or dropped if it is not possible to multiplex. There also some specific Release 15 rules that result in that some UCI bits of a certain type, for example CSI, are dropped.

In Release 16, it was agreed that a 2-level priority index indication can be configured such that HARQ-ACK, SR, and CSI can be indicated high or low priority. The intention is to enable intra-UE prioritization between different services such as eMBB and URLLC running simultaneously in a UE. The 2-level priority index is used at the physical layer for prioritization between PUCCHs and PUSCHs when there is conflict. A priority index 0 is regarded as low priority, and a priority index 1 is regarded as high priority (i.e., more important). In Release 16, only UCI with the same priority is multiplexed on PUCCH or PUSCH, and the Release 15 time-overlapping resolution procedure is run per priority. If there still are time-overlap between different priorities, the lower priority PUCCH or PUSCH is canceled. For SR, the priority index can be configured in the SchedulingRequestResourceConfig, while for HARQ-ACK in response to a DCI it can be indicated by field in the DCI or, for Semi-Persistent Scheduling (SPS), it is configured by Radio Resource Control (RRC) as for SR.

### Sequences for PUCCH Format 0 and PUCCH Format 1

Both PUCCH format 0 and PUCCH format 1 use sequences for the PUCCH transmission. The information is carried by the cyclic shift of the sequences transmitted on the PUCCH resource. Therefore, both PUCCH format 0 and PUCCH format 1 are configured with an initialCyclic shift which is used to determine the cyclic shift. For PUCCH format 0, it is the cyclic shift that carries the information, while for PUCCH format 1 the information bit(s) is first modulated (1-bit: Binary Phase Shift Keying (BPSK), 2-bits: Quadrature Phase Shift Keying (QPSK)) to a complex valued symbol which is then multiplied with the sequence.

As defined in 3GPP TS 38.211 (see, e.g., v16.1.0), the cyclic shift α depends on the symbol and slot number but also on the information the sequence carries. The cyclic shift α varies as a function of the symbol and slot number according to

$${α}_{l} = \frac{2 π}{{N}_{sc}^{RB}} ( ( {m}_{0} + {m}_{cs} + {n}_{cs} ( {n}_{s , f}^{μ} , l + {l}^{′} ) ) mod {N}_{sc}^{RB} )$$

where
n_{s,f}^{μ} is the slot number in the radio frame,
l is the Orthogonal Frequency Division Multiplexing (OFDM) symbol number in the PUCCH transmission where l=0 corresponds to the first OFDM symbol of the PUCCH transmission,
l′ is the index of the OFDM symbol in the slot that corresponds to the first OFDM symbol of the PUCCH transmission in the slot given by Third Generation Partnership Project (3GPP) Technical Specification (TS) 38.213,
m₀ is given by 3GPP TS 38.213 for PUCCH format 0 and 1 while for PUCCH format 3 and 4 is defined in subclause 6.4.1.3.3.1 of 3GPP TS 38.211,
m_{cs}=0 except for PUCCH format 0 when it depends on the information to be transmitted according to subclause 9.2 of 3GPP TS 38.213, and
N_{sc}^{RB} is the number of subcarriers per resource block (RB).
   The function n_{cs}(n_{c}, l) is given by

$${n}_{cs} ( {n}_{s , f}^{μ} , l ) = {\sum }_{m = 0}^{7} {2}^{m} c ( 8 {N}_{symb}^{slot} {n}_{s , f}^{μ} + 8 l + m )$$

where the pseudo-random sequence c(i) is defined by subclause 5.2.1 of 3GPP TS 38.211 and N_{symb}^{slot} is the number of symbols per slot. The pseudo-random sequence generator shall be initialized with cᵢₙᵢₜ=n_{ID}, where n_{ID} is given by the higher-layer parameter hoppingId if configured, otherwise n_{ID}=N_{ID}^{cell} where N_{ID}^{cell} is the cell identity (ID).

When a UE sends a positive SR and at most two HARQ-ACK information bits in a resource using PUCCH format 0, then the UE transmits the PUCCH in the PUCCH resource using PUCCH format 0 in the PRB(s) for HARQ-ACK information, but with different m_{cs} than if HARQ-ACK was sent alone. If SR-only is transmitted, the PUCCH is transmitted on the PUCCH resource for SR with m_{cs}=0.

As specified in Section 9.2.5.1 of 3GPP TS 38.213 v15.8.0, the Release 15 procedure for multiplexing SR and HARQ-ACK has the following limitation when PUCCH resource for SR and PUCCH resource for HARQ-ACK overlaps:
If a UE would transmit positive or negative SR in a resource using PUCCH format 0 and HARQ-ACK information bits in a resource using PUCCH format 1 in a slot, the UE transmits only a PUCCH with the HARQ-ACK information bits in the resource using PUCCH format 1.
   There exists also a proposal (see R1-2001016 section 5.2.2 and R1-2001027) to enhance this rule for high-priority SR and HARQ-ACK where UE would instead prioritize the SR.

### SUMMARY

Systems and methods are disclosed herein that relate to prioritization of Scheduling Requests (SRs) and Hybrid Automatic Repeat Request (HARQ) feedback information. In one embodiment, a method performed by a wireless communication device for prioritization between a Scheduling Request (SR) occasion and Hybrid Automatic Repeat Request Acknowledgment (HARQ-ACK) information scheduled on overlapping Physical Uplink Control Channel (PUCCH) resources comprising prioritizing or multiplexing a SR occasion on a first PUCCH resource and HARQ-ACK information on a second PUCCH resource, the first PUCCH resource and the second PUCCH resource at least partially overlapping in time. In this manner, latency improvement for uplink (UL) is provided without introducing higher downlink (DL) load nor inter-cell interference since unnecessary re-transmissions can be avoided.

In one embodiment, prioritizing or multiplexing the SR occasion on the first PUCCH resource and the HARQ-ACK information on the second PUCCH resource comprises prioritizing or multiplexing the SR occasion on the first PUCCH resource and the HARQ-ACK information on the second PUCCH resource based on a priority of the SR and a priority of the HARQ-ACK information.

In one embodiment, the SR occasion uses PUCCH format 0, and the HARQ-ACK information uses PUCCH format 1.

In one embodiment, prioritizing or multiplexing the SR occasion on the first PUCCH resource and the HARQ-ACK information on the second PUCCH resource comprises determining that a SR for the SR occasion is a negative SR and, responsive to determining that the SR for the SR occasion is a negative SR, dropping the SR occasion and transmitting one or more HARQ-ACK bits on the second PUCCH resource using PUCCH format 1.

In one embodiment, prioritizing or multiplexing the SR occasion on the first PUCCH resource and the HARQ-ACK information on the second PUCCH resource comprises determining that a SR for the SR occasion is not a negative SR and determining whether one or more HARQ-ACK bits to be transmitted satisfy one or more conditions. Prioritizing or multiplexing the SR occasion on the first PUCCH resource and the HARQ-ACK information on the second PUCCH resource further comprises, responsive to determining that the SR for the SR occasion is not a negative SR and determining that the one or more HARQ-ACK bits to be transmitted satisfy the one or more conditions, dropping the one or more HARQ-ACK bits and transmitting the SR on the first PUCCH resource using PUCCH format 0. In one embodiment, prioritizing or multiplexing the SR occasion on the first PUCCH resource and the HARQ-ACK information on the second PUCCH resource further comprises, responsive to determining that the SR for the SR occasion is not a negative SR and determining that the one or more HARQ-ACK bits to be transmitted do not satisfy the one or more conditions, dropping the SR occasion and transmitting one or more HARQ-ACK bits on the second PUCCH resource using PUCCH format 1. In one embodiment, the one or more conditions comprise a condition that the one or more HARQ-ACK bits indicates all ACK, a condition that the one or more HARQ-ACK bits indicates all NACK, a condition that at least one of the one or more HARQ-ACK bits indicates ACK, or a condition that at least one of the HARQ-ACK bits indicates NACK.

In one embodiment, prioritizing or multiplexing the SR occasion on the first PUCCH resource and the HARQ-ACK information on the second PUCCH resource comprises determining that a SR for the SR occasion is not a negative SR and, responsive to determining that the SR for the SR occasion is not a negative SR, dropping the one or more HARQ-ACK bits and transmitting the SR on the first PUCCH resource using PUCCH format 0.

In one embodiment, prioritizing or multiplexing the SR occasion on the first PUCCH resource and the HARQ-ACK information on the second PUCCH resource comprises determining that a SR for the SR occasion is not a negative SR and, responsive to determining that the SR for the SR occasion is not a negative SR, dropping the SR occasion and transmitting one or more HARQ-ACK bits on the second PUCCH resource using PUCCH format 1, while using a cyclic shift that is different from an initially scheduled cyclic shift.

In one embodiment, prioritizing or multiplexing the SR occasion on the first PUCCH resource and the HARQ-ACK information on the second PUCCH resource comprises multiplexing the SR and one or more HARQ-ACK bits on the first PUCCH resource by using a cyclic shift for a sequence used for the SR, the cyclic shift being a function of the one or more HARQ-ACK bits.

In one embodiment, prioritizing or multiplexing the SR occasion on the first PUCCH resource and the HARQ-ACK information on the second PUCCH resource comprises multiplexing a SR and one or more HARQ-ACK bits on one of the first PUCCH resource, the second PUCCH resource, or a modified PUCCH resource. In one embodiment, multiplexing the SR and the one or more HARQ-ACK bits on the second PUCCH resource comprises transmitting a PUCCH on the one of the first PUCCH resource, the second PUCCH resource, or a modified PUCCH resource, wherein the PUCCH comprises the HARQ-feedback information and the information that indicates the SR that is appended to the HARQ-feedback information.

In one embodiment, multiplexing the SR and the one or more HARQ-ACK bits on the second PUCCH resource by appending information that indicates the SR to HARQ-feedback information that serves as an indication of the one or more HARQ-ACK bits.

In one embodiment, the one or more HARQ-ACK bits are two or more HARQ-ACK bits, and multiplexing the SR and the one or more HARQ-ACK bits on the second PUCCH resource by appending information that indicates the SR to HARQ-feedback information, wherein the HARQ feedback information comprises a single bit that serves as an indication of the two or more HARQ-ACK bits in accordance with a predefined rule. In one embodiment, the predefined rule is one of the following rules: a predefined rule that is based on a bundling rule where the single bit is determined to be a first value if the two or more HARQ-ACK bits are ACK and to be a second value otherwise; a predefined rule that if at least one of the two or more HARQ-ACK bits is 0, the single bit is 0, and otherwise the single bit is 1; or a predefined rule that if at least one of the two or more HARQ-ACK bits is 1, the single bit is 1, and otherwise the single bit is 0.

In another embodiment, multiplexing the SR and the one or more HARQ-ACK bits comprises multiplexing the SR and the one or more HARQ-ACK bits on the second PUCCH resource by using a cyclic shift of a sequence transmitted on the second PUCCH resource to indicate whether the SR is a positive SR or a negative SR.

In one embodiment, multiplexing the SR and the one or more HARQ-ACK bits comprises multiplexing the SR and the one or more HARQ-ACK bits using a modified PUCCH resource. In one embodiment, multiplexing the SR and the one or more HARQ-ACK bits using the modified PUCCH resource comprises transmitting the HARQ-ACK bits on the modified PUCCH resource. In one embodiment, transmission of the HARQ-ACK bits on the modified PUCCH resource indicates a positive SR.

In one embodiment, a starting physical resource block (PRB) for the first PUCCH resource and a starting PRB for the second PUCCH resource are not equal, the modified PUCCH resource is determined to be a PUCCH resource with a same starting symbol index, initial cyclic shift, number of symbols, and time domain Orthogonal Cover Code (OCC) as those of the second PUCCH resource for HARQ-ACK information, and the modified PUCCH resource is located on a PRB different from an original PRB of the second PUCCH resource for the HARQ-ACK information. In one embodiment, the modified PUCCH resource is located on an original PRB of the first PUCCH resource for the SR.

In one embodiment, a starting PRB for the first PUCCH resource and a starting PRB for the second PUCCH resource are not equal, and the modified PUCCH resource is determined to be a PUCCH resource with a same starting symbol index as that of the first PUCCH resource for the SR but with a same initial cyclic shift, number of symbols, and time domain Orthogonal Cover Code, OCC, as those of the second PUCCH resource for HARQ-ACK information.

In one embodiment, an offset is further applied to the starting index of the modified PUCCH resource such that the modified PUCCH resource does not cross a slot boundary.

In one embodiment, an offset is further applied to the starting index of the modified PUCCH resource such that the modified PUCCH resource does not completely overlap with the second PUCCH resource.

In one embodiment, multiplexing the SR and the one or more HARQ-ACK bits comprises transmitting the SR using the first PUCCH resource and transmitting the one or more HARQ-ACK bits using a modified PUCCH resource. In one embodiment, the modified PUCCH resource comprises one or more Orthogonal Frequency Division Multiplexing (OFDM) symbols from the second PUCCH resource that are not overlapped in time with OFDM symbols of the first PUCCH resource. In one embodiment, the modified PUCCH resource further comprises additional OFDM symbols that are used as uplink control information, UCI, or Demodulation Reference Signal, DMRS, symbols as originally determined for the second PUCCH resource for the HARQ-ACK information.

Corresponding embodiments of a wireless communication device are also disclosed. In one embodiment, a wireless communication device for prioritization between a SR occasion and HARQ-ACK information scheduled on overlapping resources is adapted to prioritize or multiplex a SR occasion on a first PUCCH resource and HARQ-ACK information on a second PUCCH resource, the first PUCCH resource and the second PUCCH resource at least partially overlapping in time.

In another embodiment, wireless communication device for prioritization between a SR occasion and HARQ-ACK information scheduled on overlapping resources comprises one or more transmitters, one or more receivers, and processing circuitry associated with the one or more transmitters and the one or more receivers. The processing circuitry is configured to cause the wireless communication device to prioritize or multiplex a SR occasion on a first PUCCH resource and HARQ-ACK information on a second PUCCH resource, the first PUCCH resource and the second PUCCH resource at least partially overlapping in time.

Embodiments of a method performed by a base station are also disclosed. In one embodiment, a method performed by a base station for prioritization between a SR occasion and HARQ-ACK information scheduled on overlapping PUCCH resources comprises receiving a PUCCH transmission on a PUCCH resource, the PUCCH transmission comprising a SR for a SR occasion configured on a first PUCCH resource, HARQ-ACK information scheduled on a second PUCCH resource, or information that represents both the SR and the HARQ-ACK information, in accordance with a prioritization or multiplexing scheme. The PUCCH resource is either: (a) the first PUCCH resource configured for the SR occasion, (b) the second PUCCH resource configured for the HARQ-ACK information, or (c) a modified PUCCH resource. The first PUCCH resource and the second PUCCH resource at least partially overlap in time.

In one embodiment, the SR occasion uses PUCCH format 0, and the HARQ-ACK information uses PUCCH format 1.

In one embodiment, the SR is a negative SR, the PUCCH resource is the second PUCCH resource, and receiving the PUCCH transmission comprises receiving one or more HARQ-ACK bits on the second PUCCH resource using PUCCH format 1.

In one embodiment, the SR is a positive SR, the one or more HARQ bits satisfy one or more conditions, the PUCCH resource is the first PUCCH resource, receiving the PUCCH transmission comprises receiving the SR on the first PUCCH resource using PUCCH format 0, and the HARQ-ACK information is dropped.

In one embodiment, the SR is a positive SR, the one or more HARQ bits do not satisfy one or more conditions, the PUCCH resource is the second PUCCH resource, receiving the PUCCH transmission comprises receiving the one or more HARQ-ACK bits on the second PUCCH resource using PUCCH format 1, and the SR is dropped.

In one embodiment, the one or more conditions comprise a condition that the one or more HARQ-ACK bits indicates all ACK, a condition that the one or more HARQ-ACK bits indicates all NACK, a condition that at least one of the one or more HARQ-ACK bits indicates ACK, or a condition that at least one of the HARQ-ACK bits indicates NACK.

In one embodiment, the SR is a positive SR, the PUCCH resource is the first PUCCH resource, receiving the PUCCH transmission comprises receiving the SR on the first PUCCH resource using PUCCH format 0, and the HARQ-ACK information is dropped.

In one embodiment, the SR is a positive SR, the PUCCH resource is the second PUCCH resource, receiving the PUCCH transmission comprises receiving the HARQ-ACK information on the second PUCCH resource using PUCCH format 1 while using a cyclic shift that is different from an initially scheduled cyclic shift, and the SR occasion is dropped.

In one embodiment, the PUCCH resource is the first PUCCH resource and the SR and one or more HARQ-ACK bits are multiplexed on the first PUCCH resource by using a cyclic shift for a sequence used for the SR, the cyclic shift being a function of the one or more HARQ-ACK bits.

In one embodiment, the SR and one or more HARQ-ACK bits are multiplexed on the PUCCH resource. In one embodiment, the PUCCH comprises the HARQ-feedback information and the information that indicates the SR that is appended to the HARQ-feedback information.

In one embodiment, the SR and the one or more HARQ-ACK bits are multiplexed on the second PUCCH resource by using a cyclic shift of a sequence transmitted on the second PUCCH resource to indicate whether the SR is a positive SR or a negative SR.

In one embodiment, the SR and the one or more HARQ-ACK bits are multiplexed on a modified PUCCH resource.

In one embodiment, the SR is received using the first PUCCH resource and the one or more HARQ-ACK bits are received using a modified PUCCH resource.

Corresponding embodiments of a base station are also disclosed. In one embodiment, a base station for prioritization between a SR occasion and HARQ-ACK information scheduled on overlapping PUCCH resources is adapted to receive a PUCCH transmission on a PUCCH resource, the PUCCH transmission comprising a SR for a SR occasion configured on a first PUCCH resource, HARQ-ACK information scheduled on a second PUCCH resource, or information that represents both the SR and the HARQ-ACK information, in accordance with a prioritization or multiplexing scheme. The PUCCH resource is either: (a) the first PUCCH resource configured for the SR occasion, (b) the second PUCCH resource configured for the HARQ-ACK information, or (c) a modified PUCCH resource. The first PUCCH resource and the second PUCCH resource at least partially overlap in time.

In one embodiment, a base station for prioritization between a SR occasion and HARQ-ACK information scheduled on overlapping PUCCH resources comprises processing circuitry configured to cause the base station to receive a PUCCH transmission on a PUCCH resource, the PUCCH transmission comprising a SR for a SR occasion configured on a first PUCCH resource, HARQ-ACK information scheduled on a second PUCCH resource, or information that represents both the SR and the HARQ-ACK information, in accordance with a prioritization or multiplexing scheme. The PUCCH resource is either: (a) the first PUCCH resource configured for the SR occasion, (b) the second PUCCH resource configured for the HARQ-ACK information, or (c) a modified PUCCH resource. The first PUCCH resource and the second PUCCH resource at least partially overlap in time.

### BRIEF DESCRIPTION OF THE DRAWINGS

The accompanying drawing figures incorporated in and forming a part of this specification illustrate several aspects of the disclosure, and together with the description serve to explain the principles of the disclosure.

FIG. 1 illustrates one example of a cellular communications system in which embodiments of the present disclosure may be implemented;

FIG. 2 is a flow chart that illustrates the operation of a wireless communication device (e.g., a User Equipment (UE)) in accordance with at least some aspects of Embodiments 1-A and 1-B described herein;

FIG. 3 is a flow chart that illustrates the operation of a wireless communication device (e.g., a UE) in accordance with at least some aspects of Embodiment 1-C described herein;

FIG. 4 is a flow chart that illustrates the operation of a wireless communication device (e.g., a UE) in accordance with at least some aspects of Embodiment 1-D described herein;

FIG. 5 illustrates an example in which a UE would transmit a positive Scheduling Request (SR) in a resource using Physical Uplink Control Channel (PUCCH) format 0 and at most two Hybrid Automatic Repeat Request (HARQ) Acknowledgement (ACK)/Negative Acknowledgement NACK) information bits (also referred to herein as HARQ-ACK information bits) in a resource using PUCCH format 1 in a slot which would overlap in time with the SR resource;

FIG. 6, which is based on FIG. 5, illustrates an example in which a modified PUCCH resource that is determined to be a PUCCH format 1 with the same starting symbol index, initial cyclic shift, number of symbols, and time domain Orthogonal Cover Code (OCC) as those of the PUCCH format 1 for HARQ-ACK information, in accordance with an embodiment of the present disclosure;

FIG. 7 illustrates, based on FIG. 5, an example in which a modified PUCCH resource is determined to be a PUCCH format 1 with the same starting symbol index as that of the PUCCH format 0, but the same initial cyclic shift, number of symbols, and time domain OCC as those of the PUCCH format 1 for HARQ-ACK information, in accordance with another embodiment of the present disclosure;

FIG. 8 illustrates an example in which a UE would transmit positive SR in a resource using PUCCH format 0 and at most two HARQ-ACK information bits in a resource using PUCCH format 1 in a slot which would overlap in time with the SR resource;

FIG. 9 illustrates, based on FIG. 8, an example in which a modified PUCCH resource is determined to be a PUCCH format 1 with the same starting symbol index as that of the PUCCH format 0, but the same initial cyclic shift, number of symbols, and time domain OCC as those of the PUCCH format 1 for HARQ-ACK information, in accordance with one embodiment of the present disclosure;

FIG. 10 illustrates an example in which a modified PUCCH resource is determined to be a PUCCH format 1 with the starting symbol index equals that of the PUCCH format 1 for HARQ-ACK plus an offset of −1 symbol and other parameters such as initial cyclic shift, number of symbols, and time domain OCC follow those of the PUCCH format 1 for HARQ-ACK information, in accordance with another embodiment of the present disclosure;

FIG. 11 illustrates an example in which a modified PUCCH resource is determined to be a PUCCH format 1 with the starting symbol index equals that of the PUCCH format 1 for HARQ-ACK plus an offset of +1 symbol and other parameters such as initial cyclic shift, number of symbols, and time domain OCC follow those of the PUCCH format 1 for HARQ-ACK information, in accordance with another embodiment of the present disclosure;

FIG. 12 illustrates, based on FIG. 5, an example in which a modified PUCCH resource is determined to be the pre-empted PUCCH format 1 for HARQ-ACK where the overlapped symbol (overlapped with PUCCH format 0 for SR) is excluded, in accordance with an embodiment of the present disclosure;

FIG. 13 is a flow chart that illustrates the operation of a wireless communication device (e.g., a UE) in accordance with at least some of the aspects related to multiplexing embodiments described herein;

FIGS. 14, 15, and 16 are schematic block diagrams of example embodiments of a network node;

FIGS. 17 and 18 are schematic block diagrams of example embodiments of a wireless device;

FIG. 19 illustrates an example embodiment of a communication system in which embodiments of the present disclosure may be implemented;

FIG. 20 illustrates example embodiments of the host computer, base station, and UE of FIG. 19;

FIGS. 21, 22, 23, and 24 are flow charts that illustrate example embodiments of methods implemented in a communication system such as that of FIG. 19; and

FIG. 25 is a flow chart that illustrate the operation of a base station, or other network node, in accordance with embodiments of the present disclosure.

### DETAILED DESCRIPTION

The embodiments set forth below represent information to enable those skilled in the art to practice the embodiments and illustrate the best mode of practicing the embodiments. Upon reading the following description in light of the accompanying drawing figures, those skilled in the art will understand the concepts of the disclosure and will recognize applications of these concepts not particularly addressed herein. It should be understood that these concepts and applications fall within the scope of the disclosure.

Some of the embodiments contemplated herein will now be described more fully with reference to the accompanying drawings. Other embodiments, however, are contained within the scope of the subject matter disclosed herein, the disclosed subject matter should not be construed as limited to only the embodiments set forth herein; rather, these embodiments are provided by way of example to convey the scope of the subject matter to those skilled in the art.

Generally, all terms used herein are to be interpreted according to their ordinary meaning in the relevant technical field, unless a different meaning is clearly given and/or is implied from the context in which it is used. All references to a/an/the element, apparatus, component, means, step, etc. are to be interpreted openly as referring to at least one instance of the element, apparatus, component, means, step, etc., unless explicitly stated otherwise. The steps of any methods disclosed herein do not have to be performed in the exact order disclosed, unless a step is explicitly described as following or preceding another step and/or where it is implicit that a step must follow or precede another step. Any feature of any of the embodiments disclosed herein may be applied to any other embodiment, wherever appropriate. Likewise, any advantage of any of the embodiments may apply to any other embodiments, and vice versa. Other objectives, features, and advantages of the enclosed embodiments will be apparent from the following description.

Radio Node: As used herein, a “radio node” is either a radio access node or a wireless communication device.

Radio Access Node: As used herein, a “radio access node” or “radio network node” or “radio access network node” is any node in a Radio Access Network (RAN) of a cellular communications network that operates to wirelessly transmit and/or receive signals. Some examples of a radio access node include, but are not limited to, a base station (e.g., a New Radio (NR) base station (gNB) in a Third Generation Partnership Project (3GPP) Fifth Generation (5G) NR network or an enhanced or evolved Node B (eNB) in a 3GPP Long Term Evolution (LTE) network), a high-power or macro base station, a low-power base station (e.g., a micro base station, a pico base station, a home eNB, or the like), a relay node, a network node that implements part of the functionality of a base station (e.g., a network node that implements a gNB Central Unit (gNB-CU) or a network node that implements a gNB Distributed Unit (gNB-DU)) or a network node that implements part of the functionality of some other type of radio access node.

Core Network Node: As used herein, a “core network node” is any type of node in a core network or any node that implements a core network function. Some examples of a core network node include, e.g., a Mobility Management Entity (MME), a Packet Data Network Gateway (P-GW), a Service Capability Exposure Function (SCEF), a Home Subscriber Server (HSS), or the like. Some other examples of a core network node include a node implementing an Access and Mobility Management Function (AMF), a User Plane Function (UPF), a Session Management Function (SMF), an Authentication Server Function (AUSF), a Network Slice Selection Function (NSSF), a Network Exposure Function (NEF), a Network Function (NF) Repository Function (NRF), a Policy Control Function (PCF), a Unified Data Management (UDM), or the like.

Communication Device: As used herein, a “communication device” is any type of device that has access to an access network. Some examples of a communication device include, but are not limited to: mobile phone, smart phone, sensor device, meter, vehicle, household appliance, medical appliance, media player, camera, or any type of consumer electronic, for instance, but not limited to, a television, radio, lighting arrangement, tablet computer, laptop, or Personal Computer (PC). The communication device may be a portable, hand-held, computer-comprised, or vehicle-mounted mobile device, enabled to communicate voice and/or data via a wireless or wireline connection.

Wireless Communication Device: One type of communication device is a wireless communication device, which may be any type of wireless device that has access to (i.e., is served by) a wireless network (e.g., a cellular network). Some examples of a wireless communication device include, but are not limited to: a User Equipment device (UE) in a 3GPP network, a Machine Type Communication (MTC) device, and an Internet of Things (IoT) device. Such wireless communication devices may be, or may be integrated into, a mobile phone, smart phone, sensor device, meter, vehicle, household appliance, medical appliance, media player, camera, or any type of consumer electronic, for instance, but not limited to, a television, radio, lighting arrangement, tablet computer, laptop, or PC. The wireless communication device may be a portable, hand-held, computer-comprised, or vehicle-mounted mobile device, enabled to communicate voice and/or data via a wireless connection.

Network Node: As used herein, a “network node” is any node that is either part of the RAN or the core network of a cellular communications network/system.

Note that the description given herein focuses on a 3GPP cellular communications system and, as such, 3GPP terminology or terminology similar to 3GPP terminology is oftentimes used. However, the concepts disclosed herein are not limited to a 3GPP system.

Note that, in the description herein, reference may be made to the term “cell”; however, particularly with respect to 5G NR concepts, beams may be used instead of cells and, as such, it is important to note that the concepts described herein are equally applicable to both cells and beams.

There currently exist certain challenge(s). Based on the existing procedure specified by 3GPP for NR, if a Physical Uplink Control Channel (PUCCH) format 0 for a Scheduling Request (SR) and a PUCCH format 1 for Hybrid Automatic Repeat Request (HARQ) feedback (HARQ-ACK) are overlapped, the UE cannot multiplex the SR and the HARQ-ACK, and the UE prioritizes the HARQ-ACK transmission. This means that, if SR is triggered, the UE drops the SR and transmits only the HARQ-ACK.

From a latency perspective, the above limitation is undesirable, especially if the SR is associated with Ultra-Reliable Low-Latency Communication (URLLC) traffic. Therefore, it could be tempting to enhance this rule so that if both SR and HARQ-ACK information are of high priority (priority index 1), then the UE would transmit the SR instead. Upon reception of the SR, the gNB would then, however, only know that HARQ-ACK was not sent. Since the UE could have failed to detect the Physical Downlink Control Channel (PDCCH), the gNB would need to re-schedule the data taking into account that the UE may have failed detecting the PDCCH. This may reduce soft-combining gain that otherwise could be achieved. Further, such a scheme has the drawback that, since URLLC has high reliability requirements, it is likely so that HARQ-ACK indicates ACK most of the time. Hence, omitting HARQ-ACK indicating ACK lead to unnecessary transmissions on both PDCCH and Physical Downlink Shared Channel (PDSCH). Such an enhanced scheme would lead to both higher downlink (DL) load and increased DL inter-cell interference which is bad from a URLLC perspective.

Certain aspects of the present disclosure and their embodiments may provide solutions to the aforementioned or other challenges. Systems and methods are disclosed herein for prioritization and/or multiplexing SR using PUCCH format 0 and HARQ using PUCCH format 1 when the PUCCH resources overlap.

Systems and methods disclosed herein provide prioritization/multiplexing for SR and HARQ-ACK in scenario where SR would be dropped in NR Release 15.

Certain embodiments may provide one or more of the following technical advantage(s). Latency improvement for uplink (UL) (gNB is informed about SR presence) without introducing higher DL load nor inter-cell interference since unnecessary re-transmissions are avoided.

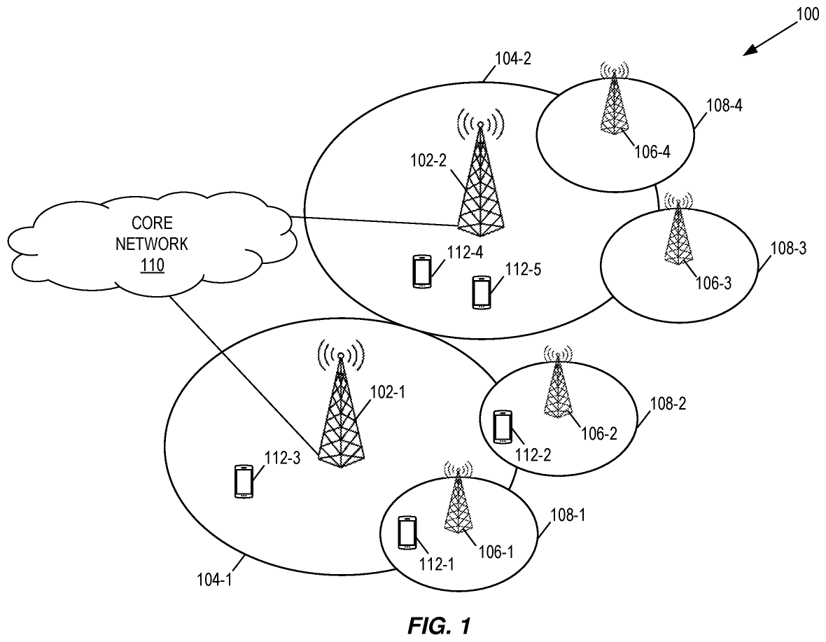

FIG. 1 illustrates one example of a cellular communications system 100 in which embodiments of the present disclosure may be implemented. In the embodiments described herein, the cellular communications system 100 is a 5G System (5GS) including a Next Generation RAN (NG-RAN) and a 5G Core (5GC). In this example, the RAN includes base stations 102-1 and 102-2, which in the 5GS include NR base stations (gNBs) and optionally next generation eNBs (ng-eNBs) (i.e., LTE RAN nodes connected to the 5GC), controlling corresponding (macro) cells 104-1 and 104-2. The base stations 102-1 and 102-2 are generally referred to herein collectively as base stations 102 and individually as base station 102. Likewise, the (macro) cells 104-1 and 104-2 are generally referred to herein collectively as (macro) cells 104 and individually as (macro) cell 104. The RAN may also include a number of low power nodes 106-1 through 106-4 controlling corresponding small cells 108-1 through 108-4. The low power nodes 106-1 through 106-4 can be small base stations (such as pico or femto base stations) or Remote Radio Heads (RRHs), or the like. Notably, while not illustrated, one or more of the small cells 108-1 through 108-4 may alternatively be provided by the base stations 102. The low power nodes 106-1 through 106-4 are generally referred to herein collectively as low power nodes 106 and individually as low power node 106. Likewise, the small cells 108-1 through 108-4 are generally referred to herein collectively as small cells 108 and individually as small cell 108. The cellular communications system 100 also includes a core network 110, which in the 5GS is referred to as the 5G Core (5GC). The base stations 102 (and optionally the low power nodes 106) are connected to the core network 110.

The base stations 102 and the low power nodes 106 provide service to wireless communication devices 112-1 through 112-5 in the corresponding cells 104 and 108. The wireless communication devices 112-1 through 112-5 are generally referred to herein collectively as wireless communication devices 112 and individually as wireless communication device 112. In the following description, the wireless communication devices 112 are oftentimes UEs and as such sometimes referred to herein as UEs or UEs 112, but the present disclosure is not limited thereto.

Now, a description of some embodiments of the present disclosure is provided.

1. Prioritization

The present disclosure teaches enhanced methods for prioritization between SR to be transmitted on a first PUCCH resource with PUCCH format 0 and one or two HARQ-ACK bit(s) to be transmitted on a second PUCCH resource with PUCCH format 1. In one embodiment, the two PUCCH occasions overlap in time. One example condition is that the two PUCCH resources have the same starting symbol. Another example condition is that the two PUCCH resources overlap over at least one Orthogonal Frequency Division Multiplexing (OFDM) symbol but may or may not have the same starting symbol.

In this method, when SR and HARQ-ACK PUCCH resources overlap, SR is prioritized over HARQ-ACK under certain conditions.

In one variation, the embodiments described below are applied only for SR designated as high-priority, while the Release 15 procedure is reused if SR is designated as low-priority. The HARQ-ACK has the same priority level as that of SR.

In another variation, the embodiments described below are applied regardless of SR priority level.

### 1.1. Embodiment 1-A. Prioritization Using Scheduled PUCCH Resources and Cyclic Shift

A SR can have one of two states, namely, a positive SR or a negative SR. A positive SR is where the UE is requesting to be scheduled. A negative SR is where the UE is not requesting to be scheduled. Note that there may be more than two SR states. Also, positive SRs are signaled, whereas negative SRs correspond to no transmission. This scheme of using positive and negative SRs is referred to as on/off keying.

In one non-limiting embodiment,
If the SR is a negative SR, then Release 15 procedure is reused, i.e., drop the SR reporting occasion and transmit only HARQ-ACK bit(s) on the HARQ-ACK PUCCH resource with PUCCH format 1 (also denoted as PF1);
Otherwise (i.e., if the SR is a positive SR), the UE drops the HARQ-ACK bit(s), and transmits SR using the SR PUCCH resource with PUCCH format 0 if the HARQ-ACKs satisfies a predefined criteria.
   Otherwise (i.e., if the SR is a positive SR but the HARQ-ACK bit(s) do not satisfy a predefined criteria), the UE drops the SR reporting occasion, and transmits HARQ-ACK information on the HARQ-ACK PUCCH resource with PUCCH format 1.

The predefined criteria can be one of the following options below.
In a first example, the predefined criteria is: the one or two HARQ-ACK bits indicates all ACK.
In a second example, the predefined criteria is: the one or two HARQ-ACK bits indicates all NACK.
In a third example, the predefined criteria is: at least one of the HARQ-ACK bits indicates ACK.
In a fourth example, the predefined criteria is: at least one of the HARQ-ACK bits indicates NACK.

For the four examples above, the first example is preferred if the probability for ACK is high (e.g., >95%), while the second example is preferred if the probability for ACK is low (e.g., >50%). Hence, the two embodiments may be combined in another embodiment wherein the UE may be semi-statically configured (e.g., via RRC) whether the rule in first or second embodiment shall be used.

### 1.2. Embodiment 1-B. Prioritization Using Scheduled PUCCH Resources and Cyclic Shift

Embodiment 1-A has the issue that the SR value (negative or positive) is not distinguishable when the HARQ-ACK bit(s) are transmitted using HARQ-ACK PUCCH resources (with format 1).

To further prioritize SR, the alternative below can be used.
If the SR is a negative SR, then Release 15 procedure is reused, i.e., drop the SR reporting occasion and transmit only HARQ-ACK bit(s) on the HARQ-ACK PUCCH resource with PUCCH format 1;
Otherwise (i.e., if the SR is a positive SR), the UE drops the HARQ-ACK bit(s), and transmits SR using the SR PUCCH resource with PUCCH format 0 (also denoted as PF0).

### 1.3. Embodiment 1-C. Prioritization Using Scheduled PUCCH Resources and Different Cyclic Shift of PF1

To transit both SR and HARQ-ACK bits when SR is positive, the alternative below can be used.
If the SR is a negative SR, then Release 15 procedure is reused, i.e., drop the SR reporting occasion and transmit only HARQ-ACK bit(s) on the HARQ-ACK PUCCH resource with PUCCH format 1. The cyclic shift (CS) is as initially scheduled.
Otherwise (i.e., if the SR is a positive SR), the UE drops the SR reporting occasion, and transmit the HARQ-ACK bit(s) using the HARQ-ACK PUCCH resource with PUCCH format 1, while using a cyclic shift different from the initially scheduled CS.
   One example is to increment the initial cyclic shift by 1.
   Another example is to increment the initial cyclic shift by 3.

### 1.4. Embodiment 1-D. Prioritization Using Scheduled PUCCH Resources and Different Cyclic Shift of PF0

In one non-limiting embodiment, the UE transmits SR using PUCCH format 0 wherein m_{cs} is determined based on HARQ-ACK bit(s) according to Table 1 or Table 2.

TABLE 1
Sequence cyclic shift m_{CS} to be used on SR PUCCH
resource for one HARQ-ACK information bit

HARQ-ACK value

| | 0 | 1 |
|---|---|---|
| Sequence cyclic shift | m_{CS} = x | m_{CS} = y |

TABLE 2
Sequence cyclic shift m_{CS} to be used on SR PUCCH
resource for two HARQ-ACK information bits

| | HARQ-ACK value | | | |
|---|---|---|---|---|
| | {0, 0} | {0, 1} | {1, 0} | {1, 1} |
| Sequence cyclic shift | m_{CS} = x | m_{CS} = y | m_{CS} = z | m_{CS} = w |

The sequence cyclic shifts x, y, z, and w in Table 1 and Table 2 are such that they are different but also different from m_{cs}=0 that is used when SR is transmitted alone, i.e. 0≠x≠y for Table 1 and 0≠x≠y≠z≠w for Table 2. One example of x, y, z, and w that can be used is:
Table 1: x=3, y=9
Table 2: x=1, y=4, z=10, and w=7

In one non-limiting embodiment, the UE transmits SR using PUCCH format 0 wherein m_{cs} is determined based on two HARQ-ACK bits according to Table 3.

TABLE 3
Sequence cyclic shift m_{CS} to be used on SR PUCCH
resource for two HARQ-ACK information bits

HARQ-ACK value

| | {0, 0} | Otherwise |
|---|---|---|
| Sequence cyclic shift | m_{CS} = 3 | m_{CS} = 9 |

In one non-limiting embodiment, the UE transmits SR using PUCCH format 0 wherein m_{cs} is determined based on two HARQ-ACK bits according to Table 4.

TABLE 4
Sequence cyclic shift m_{CS} to be used on SR PUCCH
resource for two HARQ-ACK information bits

HARQ-ACK value

| | {0, 0} | Otherwise |
|---|---|---|
| Sequence cyclic shift | m_{CS} = 3 | m_{CS} = 9 |

In one non-limiting embodiment, some RRC configurations determine whether any of the above rules should be used or not. For example, UE may be configured with a priornizePucchFormat0-over-PucchFormat1 which if enabled/configured instructs UE to apply one of the above rules.

1.5. Example Flow Charts

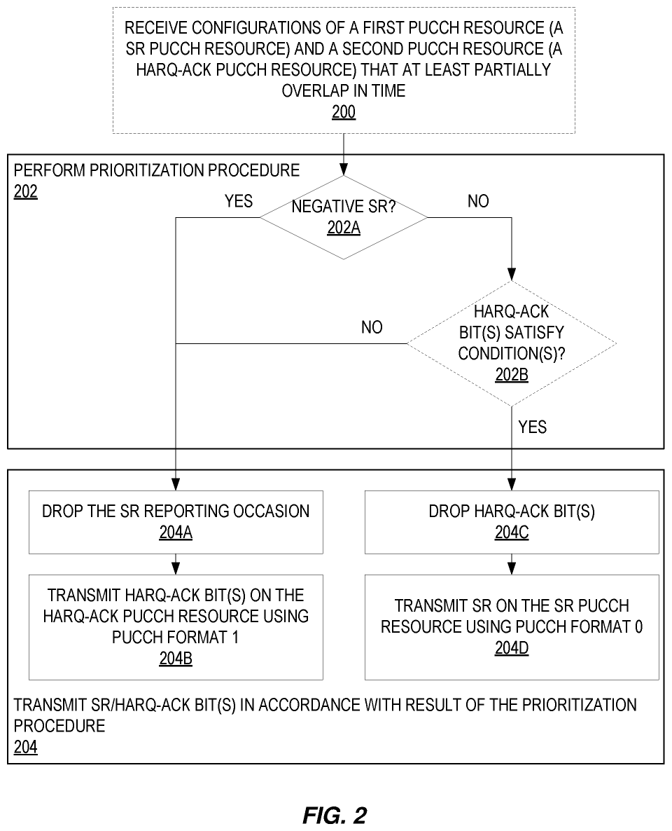

FIG. 2 is a flow chart that illustrates the operation of a wireless communication device 112 (e.g., a UE) in accordance with at least some aspects of Embodiments 1-A and 1-B described above. Optional steps are represented by dashed boxes/shapes. As illustrated, the wireless communication device 112 receives PUCCH resource configurations from a network node (e.g., a base station 102) (step 200). The PUCCH resource configurations configures a number of PUCCH resources including a first PUCCH resource (referred to herein as a SR resource) and a second PUCCH resource (referred to herein as a HARQ-ACK resource). These PUCCH resources at least partially overlap in time. The wireless communication device 112 performs a prioritization procedure by which the wireless communication device 112 determines whether to transmit a SR in the SR resource or a HARQ-ACK in the HARQ-ACK resource (step 202). The wireless communication device 112 then transmits either the SR or the HARQ-ACK in accordance with prioritization (step 204). More specifically, the wireless communication device 112 determines whether the SR for the SR resource is a negative SR (step 202A). If so, the wireless communication device 112 drops the SR (i.e., drops the SR reporting occasion) (step 204A) and transmits the HARQ-ACK bit(s) on the HARQ-ACK resource with PUCCH format 1 (step 204B).

If the SR is a positive SR, the wireless communication device 112 operates differently depending on the particular embodiment. For embodiment 1-A, the wireless communication device 112 determines whether the HARQ-ACK bit(s) satisfy one or more conditions (step 202B), as described above with respect to Embodiment 1-A. If the HARQ-ACK bit(s) do not satisfy the one or more conditions, the wireless communication device 112 drops the SR (i.e., drops the SR reporting occasion) (step 204A) and transmits the HARQ-ACK bit(s) on the HARQ-ACK resource with PUCCH format 1 (step 204B).

For embodiment 1-B, if the SR is a positive SR, the wireless communication device 112 drops the HARA-ACK bit(s) (step 204C) and transmits the SR using the SR resource with PUCCH format 0 (step 204D), as described above.

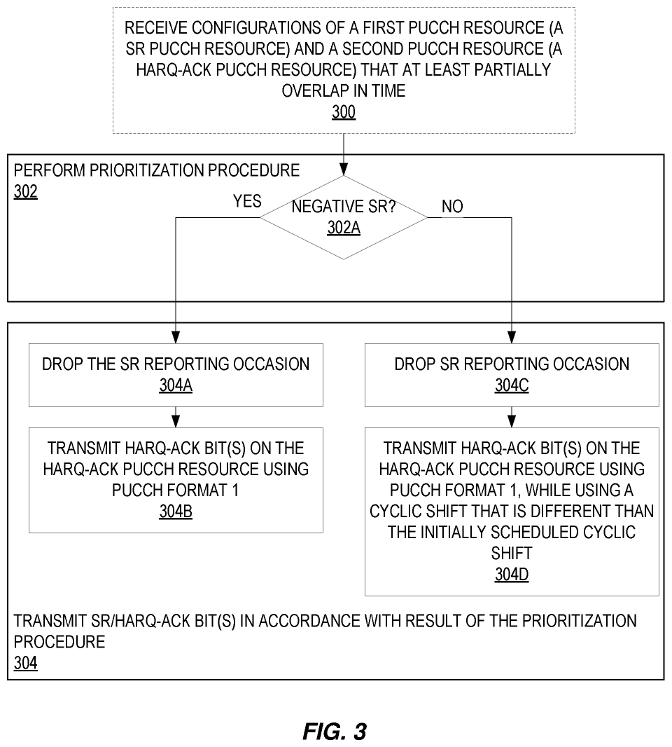

FIG. 3 is a flow chart that illustrates the operation of a wireless communication device 112 (e.g., a UE) in accordance with at least some aspects of Embodiment 1-C described above. Optional steps are represented by dashed boxes/shapes. As illustrated, the wireless communication device 112 receives PUCCH resource configurations from a network node (e.g., a base station 102) (step 300). The PUCCH resource configurations configures a number of PUCCH resources including a first PUCCH resource (referred to herein as a SR resource) and a second PUCCH resource (referred to herein as a HARQ-ACK resource). These PUCCH resources at least partially overlap in time. The wireless communication device 112 performs a prioritization procedure by which the wireless communication device 112 determines whether to transmit HARQ-ACK in the HARQ-ACK resource or to transmit both SR and HARQ-ACK (step 302). The wireless communication device 112 then transmits either the HARQ-ACK or both the SR and the HARQ-ACK in accordance with prioritization (step 304). More specifically, the wireless communication device 112 determines whether the SR for the SR resource is a negative SR (step 302A). If so, the wireless communication device 112 drops the SR (i.e., drops the SR reporting occasion) (step 304A) and transmits the HARQ-ACK bit(s) on the HARQ-ACK resource with PUCCH format 1 (step 304B).

If the SR is a positive SR, the wireless communication device 112 drops the SR reporting occasion (step 304C) and transmits the HARQ-ACK bit(s) using the HARQ-ACK resource with PUCCH format 1, while using a cycle shift that is different from an initially scheduled cyclic shift, as described above (step 304D). In this manner, both the positive SR and the HARQ-ACK bit(s) are indicated.

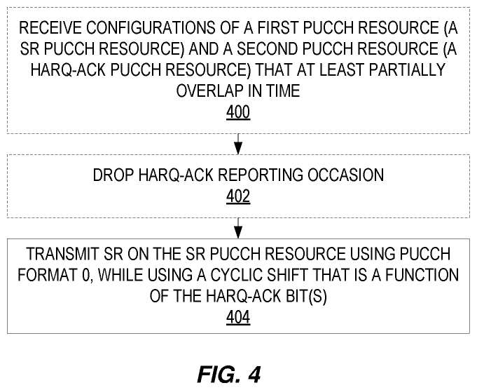

FIG. 4 is a flow chart that illustrates the operation of a wireless communication device 112 (e.g., a UE) in accordance with at least some aspects of Embodiment 1-D described above. Optional steps are represented by dashed boxes/shapes. As illustrated, the wireless communication device 112 receives PUCCH resource configurations from a network node (e.g., a base station 102) (step 400). The PUCCH resource configurations configures a number of PUCCH resources including a first PUCCH resource (referred to herein as a SR resource) and a second PUCCH resource (referred to herein as a HARQ-ACK resource). These PUCCH resources at least partially overlap in time. The wireless communication device 112 transmits a SR on the PUCCH resource using a sequence cyclic shift that is a function of the HARQ-bit(s), as described above (step 404). In one embodiment, step 404 is performed if the SR is a positive SR but not if the SR is a negative SR. Further, in one embodiment, the HARQ-ACK resource is not used (i.e., the HARQ-ACK occasion is dropped since the HARQ-ACK bit(s) are indicated via the sequence cyclic shift for the transmitted SR) (step 402).

2. Multiplexing

The present disclosure also teaches enhanced methods for multiplexing SR and HARQ-ACK where SR is to be transmitted with PUCCH format 0 and one or two HARQ-ACK bit(s) to be transmitted with PUCCH format 1 from a UE, where the two PUCCH transmissions would overlap in time.

The following embodiments apply to the case when both SR and HARQ-ACK have the same priority levels (e.g., both are with high priority index).

2.1. Modified HARQ-ACK Codebook

2.1.1. Appending SR Information

In one non-limiting embodiment, if a UE would transmit SR in a resource using PUCCH format 0 and one HARQ-ACK information bit in a resource using PUCCH format 1 which would overlap in time with the SR resource, the UE transmits a PUCCH with 2-bit information using the PUCCH format 1 resource, where the first information bit is the HARQ-ACK bit and the second information bit corresponds to a positive (e.g., value 1) or negative (e.g., value 0) SR.

In one non-limiting embodiment, if a UE would transmit SR in a resource using PUCCH format 0 and two HARQ-ACK information bits in a resource using PUCCH format 1 which would overlap in time with the SR resource, the UE transmits a PUCCH with 2-bit information using the PUCCH format 1 resource, where the first information bit is a HARQ-ACK information bit determined from the available two information bits using on a predefined rule and the second information bit corresponds to a positive (e.g., value 1) or negative (e.g., value 0) SR. The predefined rule to determine the HARQ-ACK information bit based on the available two HARQ-ACK bits at the UE, can be one of the following options below.
In a first example, the predefined rule is based on the bundling rule where the HARQ-ACK information bit is determined to be of value 1 (or 0) if both HARQ-ACK bits are ACK, and to be of value 0 (or 1) otherwise.
In a second example, the predefined rule is that if at least one of the available HARQ-ACK bits is 0, the HARQ information bit is 0, and 1, otherwise.
In a third example, the predefined rule is that if at least one of the available HARQ-ACK bits is 1, the HARQ information bit is 1, and 0, otherwise.

2.1.2. Multiplexing SR Information Using a Cyclic Shift Offset

In one non-limiting embodiment, if a UE would transmit a positive SR in a resource using PUCCH format 0 and at most two HARQ-ACK information bits in a resource using PUCCH format 1 which would overlap in time with the SR resource, the UE transmits the PUCCH in the resource using PUCCH format 1 for HARQ-ACK information with m_{cs}=6 or any non-zero value (instead of m_{cs}=0) for the value of cyclic shift α described in Section 6.3.2.2.2 in TS 38.211, V16.1.0. The cyclic shift offset used for the PUCCH transmission indicates a positive SR.

If a UE would not transmit a positive SR in a resource using PUCCH format 0 and would transmit at most two HARQ-ACK information bits in a resource using PUCCH format 1 which would overlap in time with the SR resource, the UE transmits the PUCCH in the resource using PUCCH format 1 for HARQ-ACK information with m_{cs}=0 for the value of cyclic shift α as originally described in Section 6.3.2.2.2 in TS 38.211, V16.1.0. The cyclic shift offset used for the PUCCH transmission indicates a negative SR.

2.2. Modified PUCCH Resource in Case of Positive SR

In one non-limiting embodiment, if a UE would transmit positive SR in a resource using PUCCH format 0 and at most two HARQ-ACK information bits in a resource using PUCCH format 1 in a slot which would overlap in time with the SR resource, the UE determines a modified PUCCH resource, and transmits HARQ-ACK information in a PUCCH using the modified PUCCH resource. The modified PUCCH resource used for the PUCCH transmission indicates a positive SR.

If a UE would not transmit a positive SR in a resource using PUCCH format 0 and would transmit at most two HARQ-ACK information bits in a resource using PUCCH format 1 in a slot which would overlap in time with the SR resource, the UE transmits a PUCCH in the resource using PUCCH format 1 for HARQ-ACK information. The (non-modified) PUCCH resource used for the PUCCH transmission indicates a negative SR.

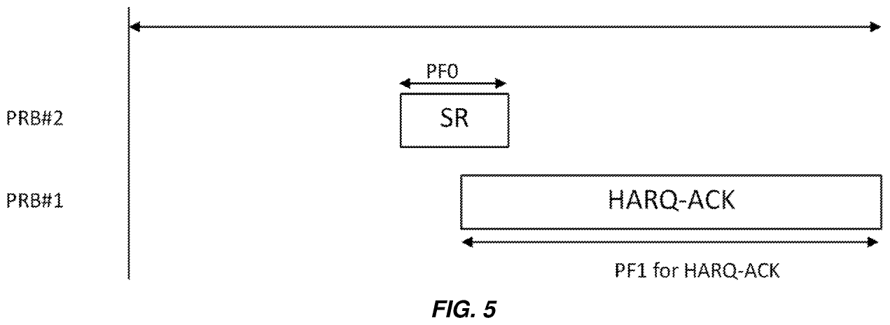

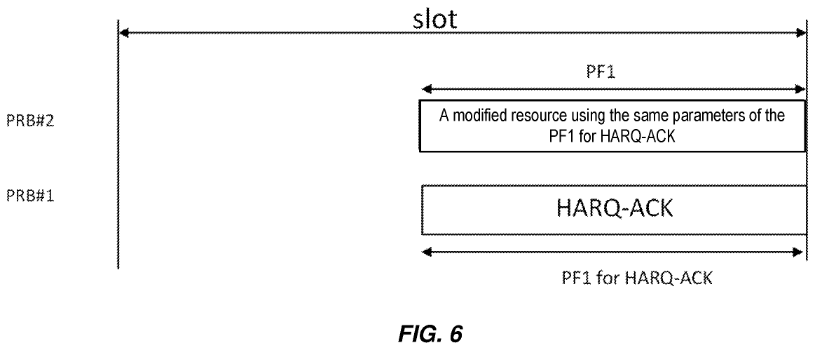

In one version of the above embodiment, if the configured starting PRBs for PUCCH format 0 for SR and PUCCH format 1 for HARQ-ACK are not equal, the modified PUCCH resource is determined to be a PUCCH format 1 with the same starting symbol index, initial cyclic shift, number of symbols, and time domain Orthogonal Cover Code (OCC) as those of the PUCCH format 1 for HARQ-ACK information. The modified PUCCH resource is located on a PRB different from the original PRB of PUCCH format 1 for HARQ-ACK. As a preferred embodiment, the modified PUCCH resource is located on the original PRB of PUCCH format 0 for SR. An illustrating example is given in FIG. 6 based on an example of overlapped PUCCH resources of SR and HARQ-ACK as in FIG. 5.

FIG. 5 illustrates an example where a UE would transmit positive SR in a resource using PUCCH format 0 and at most two HARQ-ACK information bits in a resource using PUCCH format 1 in a slot which would overlap in time with the SR resource.

FIG. 6, which is based on FIG. 5, illustrates a modified PUCCH resource that is determined to be a PUCCH format 1 with the same starting symbol index, initial cyclic shift, number of symbols, and time domain OCC as those of the PUCCH format 1 for HARQ-ACK information.

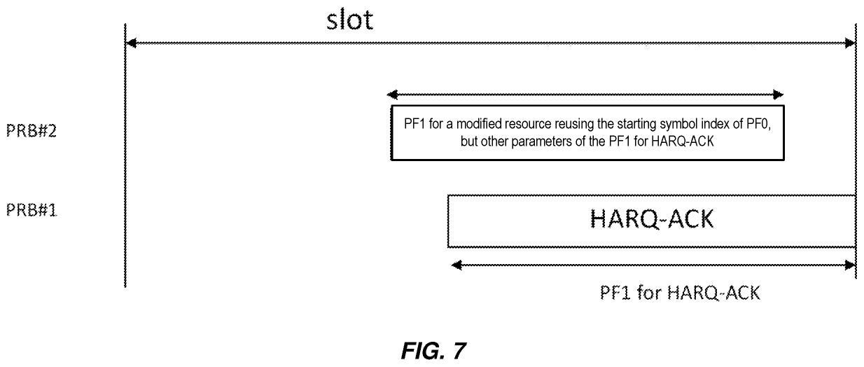

In another version of the above embodiment, if the configured starting PRBs for PUCCH format 0 for SR and PUCCH format 1 for HARQ-ACK are not equal, the modified PUCCH resource is determined to be a PUCCH format 1 with the same starting symbol index as that of the PUCCH format 0 originally configured for SR, but with the same initial cyclic shift, number of symbols, and time domain OCC as those of the PUCCH format 1 for HARQ-ACK information. The modified PUCCH resource is located on a PRB different from the original PRB of PUCCH format 1 for HARQ-ACK. As a preferred embodiment, the modified PUCCH resource is located on the original PRB of PUCCH format 0 for SR. An illustrating example is given in FIG. 7 based on an example of overlapped PUCCH resources of SR and HARQ-ACK as in FIG. 5.

FIG. 7 illustrates, based on FIG. 5, a modified PUCCH resource is determined to be a PUCCH format 1 with the same starting symbol index as that of the PUCCH format 0, but the same initial cyclic shift, number of symbols, and time domain OCC as those of the PUCCH format 1 for HARQ-ACK information.

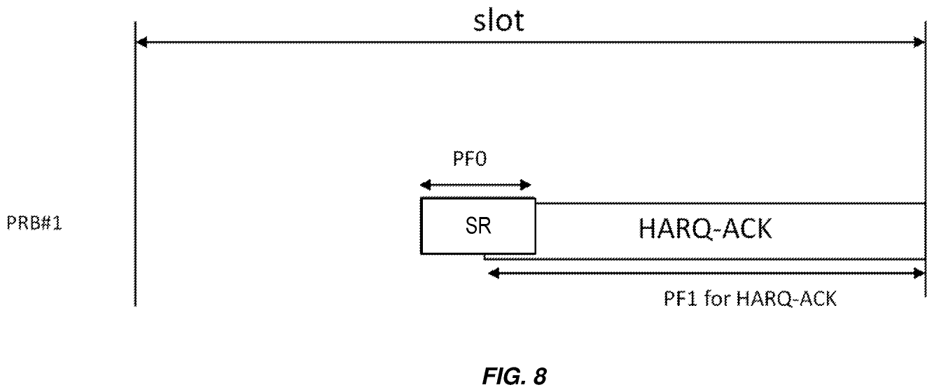

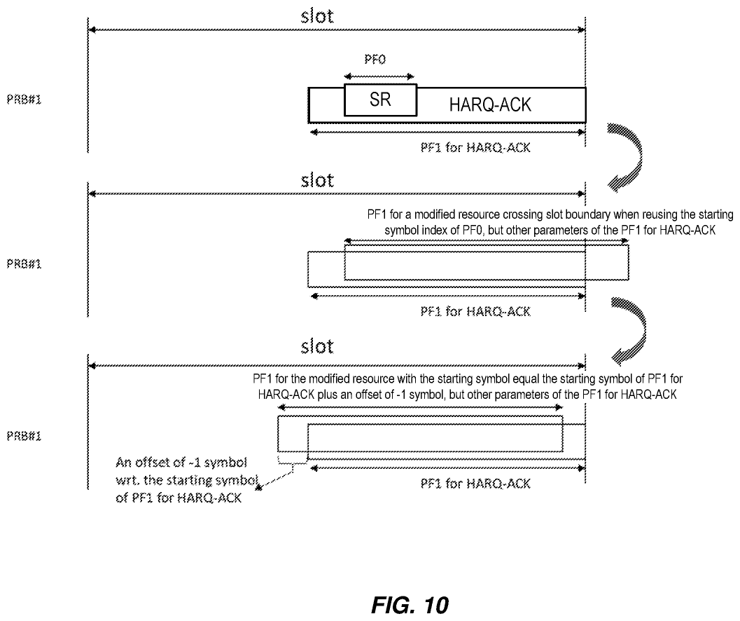

In one version of the above embodiment, if the configured starting PRBs for PUCCH format 0 for SR and PUCCH format 1 for HARQ-ACK is the same, the modified PUCCH resource is determined to be a PUCCH format 1 with the same starting symbol index as that of the PUCCH format 0 originally configured for SR, but with the same initial cyclic shift, number of symbols, and time domain OCC as those of the PUCCH format 1 for HARQ-ACK information. If the PUCCH format 1 is 14 symbols long, the UE may transmit only a PUCCH with the HARQ-ACK information bits in the resource using PUCCH format 1. An illustrating example is given in FIG. 10 based on an example of overlapped PUCCH resources of SR and HARQ-ACK as in FIG. 8.

FIG. 8 illustrates an example where a UE would transmit positive SR in a resource using PUCCH format 0 and at most two HARQ-ACK information bits in a resource using PUCCH format 1 in a slot which would overlap in time with the SR resource.

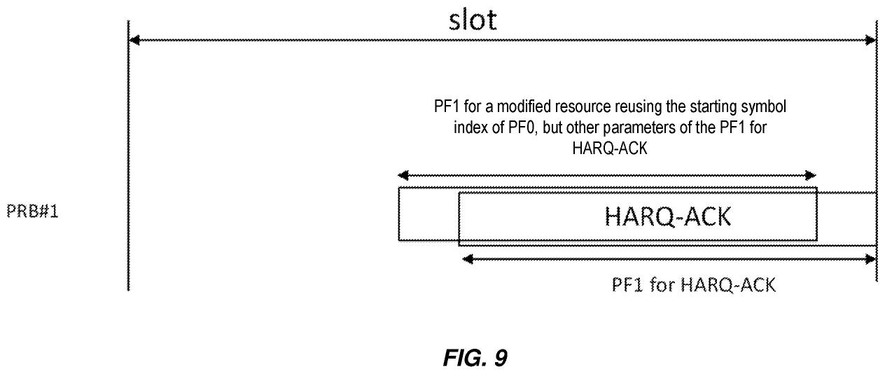

FIG. 9 illustrates, based on FIG. 8, a modified PUCCH resource is determined to be a PUCCH format 1 with the same starting symbol index as that of the PUCCH format 0, but the same initial cyclic shift, number of symbols, and time domain OCC as those of the PUCCH format 1 for HARQ-ACK information.

For above descriptions, if the modified PUCCH resource would be determined to cross a slot boundary or completely overlap with the original PUCCH format 1 for HARQ-ACK, the starting symbol index of the modified PUCCH resource is determined to be equal to the starting symbol index of the original PUCCH 1 for HARQ-ACK plus an offset value. One or more offset values can be configured, and one is used depending on how the SR resource is overlapped with the HARQ-ACK resource.

In one example, in FIG. 10 where PUCCH format 0 for SR starts in the first half of the PUCCH format 1 for HARQ-ACK, reusing the starting symbol of PUCCH format 0 for SR but other parameters from PUCCH format 1 for HARQ-ACK would result in a modified PUCCH resource crossing a slot boundary. A negative offset value of −1 symbol is applied to the starting symbol index of the original PUCCH 1 for HARQ-ACK to determine the actual starting symbol of the modified PUCCH resource. In other words, FIG. 10 illustrates the modified PUCCH resource is determined to be a PUCCH format 1 with the starting symbol index equals that of the PUCCH format 1 for HARQ-ACK plus an offset of −1 symbol. Other parameters such as initial cyclic shift, number of symbols, and time domain OCC follow those of the PUCCH format 1 for HARQ-ACK information.

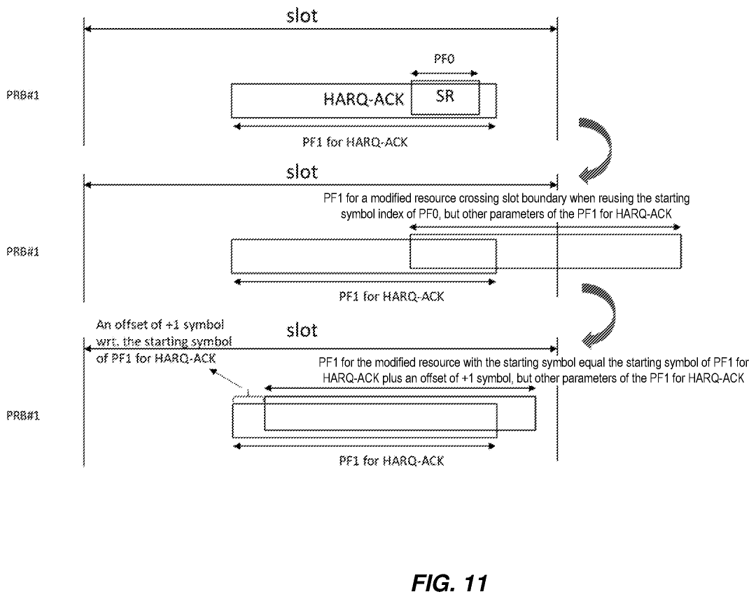

In another example, in FIG. 11, where PUCCH format 0 for SR starts in the second half of the PUCCH format 1 for HARQ-ACK, reusing the starting symbol of PUCCH format 0 for SR but other parameters from PUCCH format 1 for HARQ-ACK would result in a modified PUCCH resource crossing a slot boundary. A negative offset value of −1 symbol is applied to the starting symbol index of the original PUCCH 1 for HARQ-ACK to determine the actual starting symbol of the modified PUCCH resource. In other words, FIG. 11 illustrates the modified PUCCH resource is determined to be a PUCCH format 1 with the starting symbol index equals that of the PUCCH format 1 for HARQ-ACK plus an offset of +1 symbol. Other parameters such as initial cyclic shift, number of symbols, and time domain OCC follow those of the PUCCH format 1 for HARQ-ACK information.

2.3. Pre-Empted PUCCH Resource for HARQ-ACK Transmission

In one non-limiting embodiment, if a UE would transmit positive SR in a resource using PUCCH format 0 and at most two HARQ-ACK information bits in a resource using PUCCH format 1 in a slot which would overlap in time with the SR resource, the UE determines a modified PUCCH resource for HARQ-ACK transmission, and transmits SR using the PUCCH format 0 resource and HARQ-ACK information bits using the modified PUCCH resource.

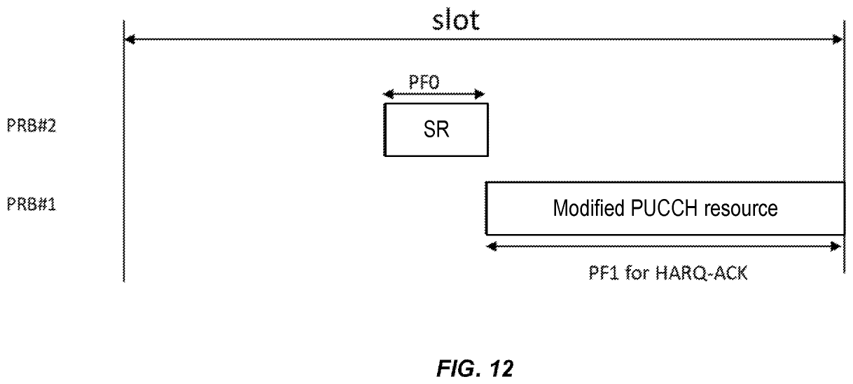

In one version of the above embodiment, the modified PUCCH resource is the preempted PUCCH format 1 resource where the OFDM symbols which are overlapped in time with those of the PUCCH format 0 are excluded. The remaining OFDM symbols of the modified PUCCH resources are used as UCI or Demodulation Reference Signal (DMRS) symbols as originally determined for the PUCCH format 1 for HARQ-ACK information. In case that intra-slot frequency hopping is enabled for the PUCCH format 1, the PRB indices for each remaining symbol are the same as originally determined for the PUCCH format 1. An illustrating example is given in FIG. 12 based on an example of overlapped PUCCH resources of SR and HARQ-ACK in FIG. 5. FIG. 12 illustrates, based on FIG. 5, a modified PUCCH resource is determined to be the pre-empted PUCCH format 1 for HARQ-ACK where the overlapped symbol (overlapped with PUCCH format 0 for SR) is excluded.

In one version of the above embodiment, the modified PUCCH resource is used for HARQ-ACK transmission only if the remaining number of symbols (non-overlapped symbols) is larger than 3.

2.4. Example Flow Chart

FIG. 13 is a flow chart that illustrates the operation of a wireless communication device 112 (e.g., a UE) in accordance with at least some of the aspects above related to the multiplexing embodiments. Optional steps are represented by dashed boxes. As illustrated, the wireless communication device 112 receives PUCCH resource configurations from a network node (e.g., a base station 102) (step 400). The PUCCH resource configurations configures a number of PUCCH resources including a first PUCCH resource (referred to herein as a SR resource) and a second PUCCH resource (referred to herein as a HARQ-ACK resource). These PUCCH resources at least partially overlap in time. The wireless communication device 112 multiplexes a SR and HARQ-ACK bit(s) in accordance with any of the embodiments described above (step 1302). For example, in one embodiment, the wireless communication device 112 multiplexes the SR and HARQ-ACK bit(s) using a modified HARQ-ACK codebook (step 1302A). This may be done by, for example, appending SR information to the HARQ-ACK bit(s) (step 1302A1) or by using a cyclic shift offset (step 1302A2). In another embodiment, the wireless communication device 112 multiplexes the SR and HARQ-ACK bit(s) using a modified PUCCH resource, in the case of a positive SR (step 1302B). In another embodiment, the wireless communication device 112 multiplexes the SR and HARQ-ACK bit(s) using pre-empted SR resource for transmission of HARQ-ACK bit(s) (step 1302C).

3. Different Priority

In the following embodiments, SR and HARQ-ACK have different priority levels and the above-mentioned rules are used based on the priorities of SR and HARQ-ACK.

In one exemplary scenario, if SR and HARQ-ACK have the same priorities, one of the rules in Section 1 or 2 is used, otherwise the one with lower priority is dropped.

In another exemplifying embodiment, if SR has higher priority, then one of the rules in Section 1 or 2 is used. Otherwise, SR is dropped/canceled or multiplexed with HARQ-ACK according to one of the rules in Section 2.

4. Additional Details

Now a description of some additional details that are applicable to all of the embodiments described is provided. However, first, it should be noted that while the description above focus on the operation of the wireless communication device 112 or UE, there are corresponding embodiments of the operation of the base station 102 or gNB. For instance, the base station 102 or gNB provides the configuration (or scheduling) of the overlapping PUCCH resources to the wireless communication device 112 or UE and receives the prioritized or multiplexed UCI (i.e., the SR, the HARQ-ACK bit(s), or information that represents both the SR and the HARQ-ACK bit(s) (i.e., the multiplexed information)) in accordance with the embodiments described above.

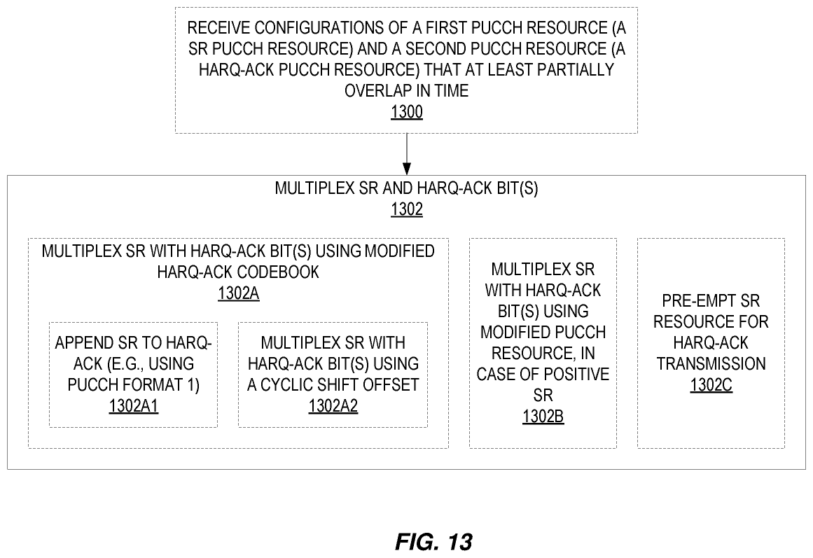

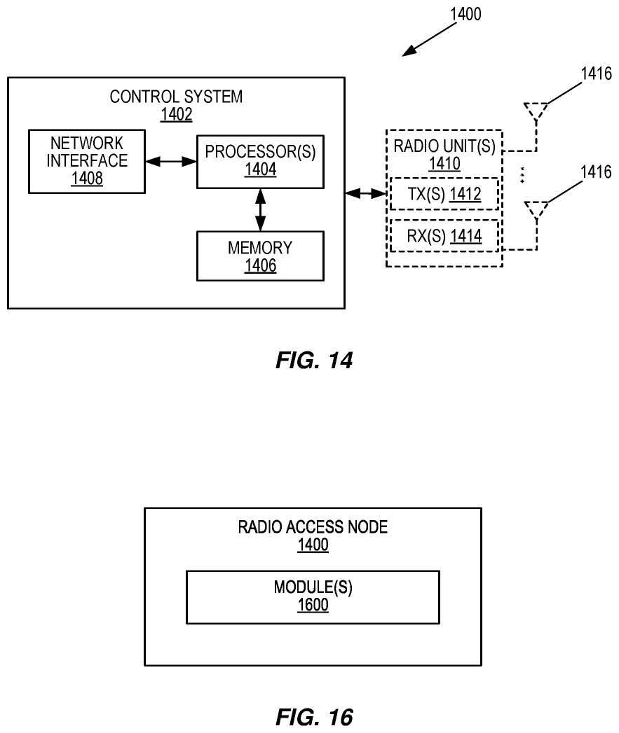

FIG. 14 is a schematic block diagram of a radio access node 1400 according to some embodiments of the present disclosure. Optional features are represented by dashed boxes. The radio access node 1400 may be, for example, a base station 102 or 106 or a network node that implements all or part of the functionality of the base station 102 or gNB described herein. As illustrated, the radio access node 1400 includes a control system 1402 that includes one or more processors 1404 (e.g., Central Processing Units (CPUs), Application Specific Integrated Circuits (ASICs), Field Programmable Gate Arrays (FPGAs), and/or the like), memory 1406, and a network interface 1408. The one or more processors 1404 are also referred to herein as processing circuitry. In addition, the radio access node 1400 may include one or more radio units 1410 that each includes one or more transmitters 1412 and one or more receivers 1414 coupled to one or more antennas 1416. The radio units 1410 may be referred to or be part of radio interface circuitry. In some embodiments, the radio unit(s) 1410 is external to the control system 1402 and connected to the control system 1402 via, e.g., a wired connection (e.g., an optical cable). However, in some other embodiments, the radio unit(s) 1410 and potentially the antenna(s) 1416 are integrated together with the control system 1402. The one or more processors 1404 operate to provide one or more functions of a radio access node 1400 as described herein. In some embodiments, the function(s) are implemented in software that is stored, e.g., in the memory 1406 and executed by the one or more processors 1404.

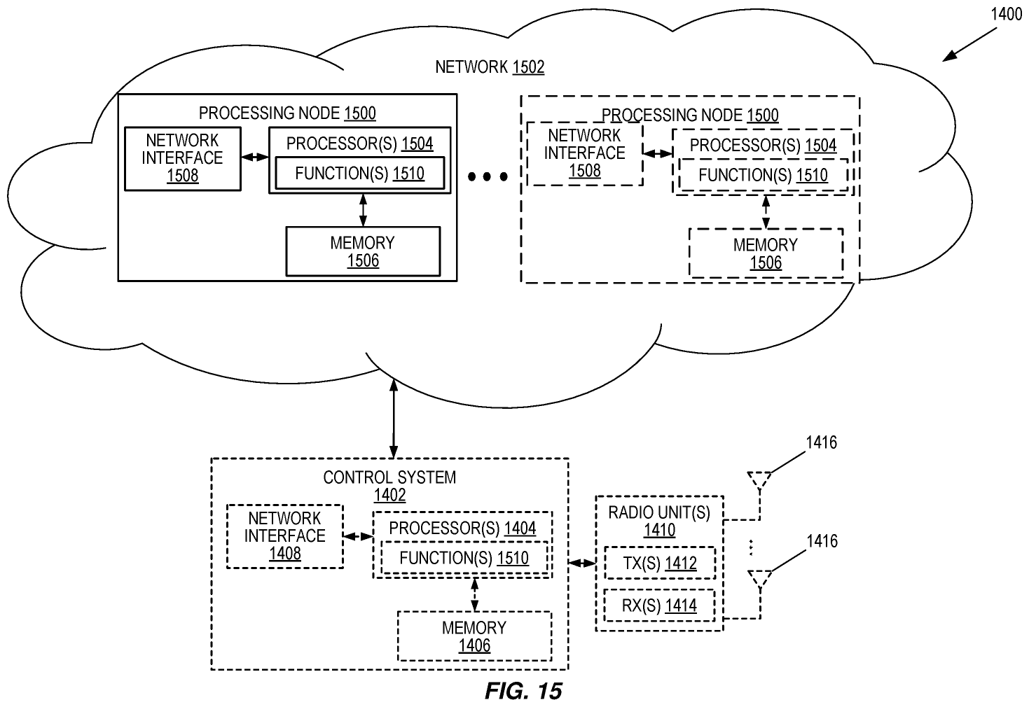

FIG. 15 is a schematic block diagram that illustrates a virtualized embodiment of the radio access node 1400 according to some embodiments of the present disclosure. This discussion is equally applicable to other types of network nodes. Further, other types of network nodes may have similar virtualized architectures. Again, optional features are represented by dashed boxes.

As used herein, a “virtualized” radio access node is an implementation of the radio access node 1400 in which at least a portion of the functionality of the radio access node 1400 is implemented as a virtual component(s) (e.g., via a virtual machine(s) executing on a physical processing node(s) in a network(s)). As illustrated, in this example, the radio access node 1400 may include the control system 1402 and/or the one or more radio units 1410, as described above. The control system 1402 may be connected to the radio unit(s) 1410 via, for example, an optical cable or the like. The radio access node 1400 includes one or more processing nodes 1500 coupled to or included as part of a network(s) 1502. If present, the control system 1402 or the radio unit(s) are connected to the processing node(s) 1500 via the network 1502. Each processing node 1500 includes one or more processors 1504 (e.g., CPUs, ASICs, FPGAs, and/or the like), memory 1506, and a network interface 1508.

In this example, functions 1510 of the radio access node 1400 described herein are implemented at the one or more processing nodes 1500 or distributed across the one or more processing nodes 1500 and the control system 1402 and/or the radio unit(s) 1410 in any desired manner. In some particular embodiments, some or all of the functions 1510 of the radio access node 1400 described herein are implemented as virtual components executed by one or more virtual machines implemented in a virtual environment(s) hosted by the processing node(s) 1500. As will be appreciated by one of ordinary skill in the art, additional signaling or communication between the processing node(s) 1500 and the control system 1402 is used in order to carry out at least some of the desired functions 1510. Notably, in some embodiments, the control system 1402 may not be included, in which case the radio unit(s) 1410 communicate directly with the processing node(s) 1500 via an appropriate network interface(s).

In some embodiments, a computer program including instructions which, when executed by at least one processor, causes the at least one processor to carry out the functionality of radio access node 1400 or a node (e.g., a processing node 1500) implementing one or more of the functions 1510 of the radio access node 1400 in a virtual environment according to any of the embodiments described herein is provided. In some embodiments, a carrier comprising the aforementioned computer program product is provided. The carrier is one of an electronic signal, an optical signal, a radio signal, or a computer readable storage medium (e.g., a non-transitory computer readable medium such as memory).

FIG. 16 is a schematic block diagram of the radio access node 1400 according to some other embodiments of the present disclosure. The radio access node 1400 includes one or more modules 1600, each of which is implemented in software. The module(s) 1600 provide the functionality of the radio access node 1400 described herein. This discussion is equally applicable to the processing node 1500 of FIG. 15 where the modules 1600 may be implemented at one of the processing nodes 1500 or distributed across multiple processing nodes 1500 and/or distributed across the processing node(s) 1500 and the control system 1402.

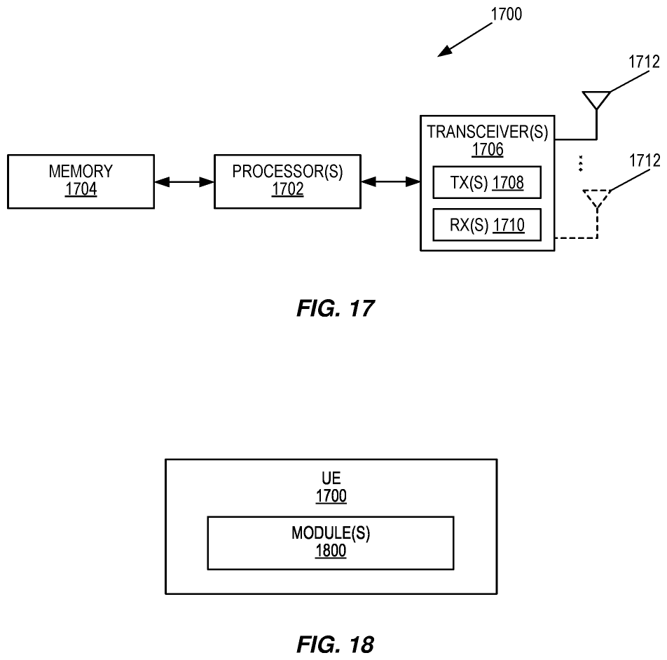

FIG. 17 is a schematic block diagram of a wireless communication device 1700 according to some embodiments of the present disclosure. As illustrated, the wireless communication device 1700 includes one or more processors 1702 (e.g., CPUs, ASICs, FPGAs, and/or the like), memory 1704, and one or more transceivers 1706 each including one or more transmitters 1708 and one or more receivers 1710 coupled to one or more antennas 1712. The transceiver(s) 1706 includes radio-front end circuitry connected to the antenna(s) 1712 that is configured to condition signals communicated between the antenna(s) 1712 and the processor(s) 1702, as will be appreciated by on of ordinary skill in the art. The processors 1702 are also referred to herein as processing circuitry. The transceivers 1706 are also referred to herein as radio circuitry. In some embodiments, the functionality of the wireless communication device 1700 described above may be fully or partially implemented in software that is, e.g., stored in the memory 1704 and executed by the processor(s) 1702. Note that the wireless communication device 1700 may include additional components not illustrated in FIG. 17 such as, e.g., one or more user interface components (e.g., an input/output interface including a display, buttons, a touch screen, a microphone, a speaker(s), and/or the like and/or any other components for allowing input of information into the wireless communication device 1700 and/or allowing output of information from the wireless communication device 1700), a power supply (e.g., a battery and associated power circuitry), etc.

In some embodiments, a computer program including instructions which, when executed by at least one processor, causes the at least one processor to carry out the functionality of the wireless communication device 1700 according to any of the embodiments described herein is provided. In some embodiments, a carrier comprising the aforementioned computer program product is provided. The carrier is one of an electronic signal, an optical signal, a radio signal, or a computer readable storage medium (e.g., a non-transitory computer readable medium such as memory).

FIG. 18 is a schematic block diagram of the wireless communication device 1700 according to some other embodiments of the present disclosure. The wireless communication device 1700 includes one or more modules 1800, each of which is implemented in software. The module(s) 1800 provide the functionality of the wireless communication device 1700 described herein.

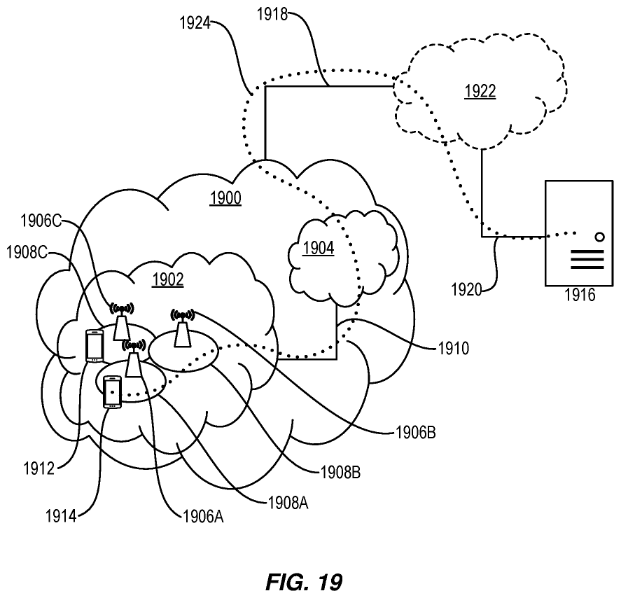

With reference to FIG. 19, in accordance with an embodiment, a communication system includes a telecommunication network 1900, such as a 3GPP-type cellular network, which comprises an access network 1902, such as a RAN, and a core network 1904. The access network 1902 comprises a plurality of base stations 1906A, 1906B, 1906C, such as Node Bs, eNBs, gNBs, or other types of wireless Access Points (APs), each defining a corresponding coverage area 1908A, 1908B, 1908C. Each base station 1906A, 1906B, 1906C is connectable to the core network 1904 over a wired or wireless connection 1910. A first UE 1912 located in coverage area 1908C is configured to wirelessly connect to, or be paged by, the corresponding base station 1906C. A second UE 1914 in coverage area 1908A is wirelessly connectable to the corresponding base station 1906A. While a plurality of UEs 1912, 1914 are illustrated in this example, the disclosed embodiments are equally applicable to a situation where a sole UE is in the coverage area or where a sole UE is connecting to the corresponding base station 1906.

The telecommunication network 1900 is itself connected to a host computer 1916, which may be embodied in the hardware and/or software of a standalone server, a cloud-implemented server, a distributed server, or as processing resources in a server farm. The host computer 1916 may be under the ownership or control of a service provider, or may be operated by the service provider or on behalf of the service provider. Connections 1918 and 1920 between the telecommunication network 1900 and the host computer 1916 may extend directly from the core network 1904 to the host computer 1916 or may go via an optional intermediate network 1922. The intermediate network 1922 may be one of, or a combination of more than one of, a public, private, or hosted network; the intermediate network 1922, if any, may be a backbone network or the Internet; in particular, the intermediate network 1922 may comprise two or more sub-networks (not shown).

The communication system of FIG. 19 as a whole enables connectivity between the connected UEs 1912, 1914 and the host computer 1916. The connectivity may be described as an Over-the-Top (OTT) connection 1924. The host computer 1916 and the connected UEs 1912, 1914 are configured to communicate data and/or signaling via the OTT connection 1924, using the access network 1902, the core network 1904, any intermediate network 1922, and possible further infrastructure (not shown) as intermediaries. The OTT connection 1924 may be transparent in the sense that the participating communication devices through which the OTT connection 1924 passes are unaware of routing of uplink and downlink communications. For example, the base station 1906 may not or need not be informed about the past routing of an incoming downlink communication with data originating from the host computer 1916 to be forwarded (e.g., handed over) to a connected UE 1912. Similarly, the base station 1906 need not be aware of the future routing of an outgoing uplink communication originating from the UE 1912 towards the host computer 1916.

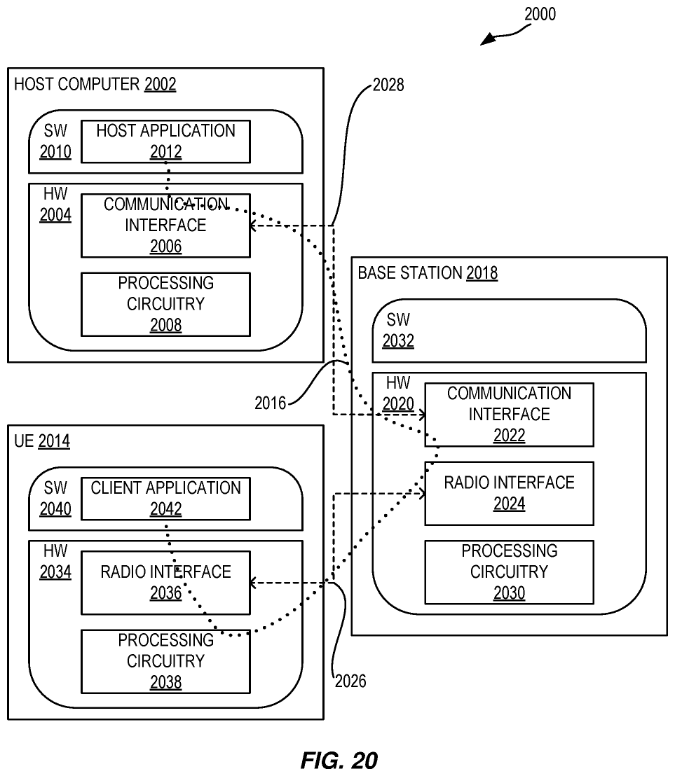

Example implementations, in accordance with an embodiment, of the UE, base station, and host computer discussed in the preceding paragraphs will now be described with reference to FIG. 20. In a communication system 2000, a host computer 2002 comprises hardware 2004 including a communication interface 2006 configured to set up and maintain a wired or wireless connection with an interface of a different communication device of the communication system 2000. The host computer 2002 further comprises processing circuitry 2008, which may have storage and/or processing capabilities. In particular, the processing circuitry 2008 may comprise one or more programmable processors, ASICs, FPGAs, or combinations of these (not shown) adapted to execute instructions. The host computer 2002 further comprises software 2010, which is stored in or accessible by the host computer 2002 and executable by the processing circuitry 2008. The software 2010 includes a host application 2012. The host application 2012 may be operable to provide a service to a remote user, such as a UE 2014 connecting via an OTT connection 2016 terminating at the UE 2014 and the host computer 2002. In providing the service to the remote user, the host application 2012 may provide user data which is transmitted using the OTT connection 2016.

The communication system 2000 further includes a base station 2018 provided in a telecommunication system and comprising hardware 2020 enabling it to communicate with the host computer 2002 and with the UE 2014. The hardware 2020 may include a communication interface 2022 for setting up and maintaining a wired or wireless connection with an interface of a different communication device of the communication system 2000, as well as a radio interface 2024 for setting up and maintaining at least a wireless connection 2026 with the UE 2014 located in a coverage area (not shown in FIG. 20) served by the base station 2018. The communication interface 2022 may be configured to facilitate a connection 2028 to the host computer 2002. The connection 2028 may be direct or it may pass through a core network (not shown in FIG. 20) of the telecommunication system and/or through one or more intermediate networks outside the telecommunication system. In the embodiment shown, the hardware 2020 of the base station 2018 further includes processing circuitry 2030, which may comprise one or more programmable processors, ASICs, FPGAs, or combinations of these (not shown) adapted to execute instructions. The base station 2018 further has software 2032 stored internally or accessible via an external connection.

The communication system 2000 further includes the UE 2014 already referred to. The UE's 2014 hardware 2034 may include a radio interface 2036 configured to set up and maintain a wireless connection 2026 with a base station serving a coverage area in which the UE 2014 is currently located. The hardware 2034 of the UE 2014 further includes processing circuitry 2038, which may comprise one or more programmable processors, ASICs, FPGAs, or combinations of these (not shown) adapted to execute instructions. The UE 2014 further comprises software 2040, which is stored in or accessible by the UE 2014 and executable by the processing circuitry 2038. The software 2040 includes a client application 2042. The client application 2042 may be operable to provide a service to a human or non-human user via the UE 2014, with the support of the host computer 2002. In the host computer 2002, the executing host application 2012 may communicate with the executing client application 2042 via the OTT connection 2016 terminating at the UE 2014 and the host computer 2002. In providing the service to the user, the client application 2042 may receive request data from the host application 2012 and provide user data in response to the request data. The OTT connection 2016 may transfer both the request data and the user data. The client application 2042 may interact with the user to generate the user data that it provides.

It is noted that the host computer 2002, the base station 2018, and the UE 2014 illustrated in FIG. 20 may be similar or identical to the host computer 1916, one of the base stations 1906A, 1906B, 1906C, and one of the UEs 1912, 1914 of FIG. 19, respectively. This is to say, the inner workings of these entities may be as shown in FIG. 20 and independently, the surrounding network topology may be that of FIG. 19.

In FIG. 20, the OTT connection 2016 has been drawn abstractly to illustrate the communication between the host computer 2002 and the UE 2014 via the base station 2018 without explicit reference to any intermediary devices and the precise routing of messages via these devices. The network infrastructure may determine the routing, which may be configured to hide from the UE 2014 or from the service provider operating the host computer 2002, or both. While the OTT connection 2016 is active, the network infrastructure may further take decisions by which it dynamically changes the routing (e.g., on the basis of load balancing consideration or reconfiguration of the network).

The wireless connection 2026 between the UE 2014 and the base station 2018 is in accordance with the teachings of the embodiments described throughout this disclosure. One or more of the various embodiments improve the performance of OTT services provided to the UE 2014 using the OTT connection 2016, in which the wireless connection 2026 forms the last segment.

A measurement procedure may be provided for the purpose of monitoring data rate, latency, and other factors on which the one or more embodiments improve. There may further be an optional network functionality for reconfiguring the OTT connection 2016 between the host computer 2002 and the UE 2014, in response to variations in the measurement results. The measurement procedure and/or the network functionality for reconfiguring the OTT connection 2016 may be implemented in the software 2010 and the hardware 2004 of the host computer 2002 or in the software 2040 and the hardware 2034 of the UE 2014, or both. In some embodiments, sensors (not shown) may be deployed in or in association with communication devices through which the OTT connection 2016 passes; the sensors may participate in the measurement procedure by supplying values of the monitored quantities exemplified above, or supplying values of other physical quantities from which the software 2010, 2040 may compute or estimate the monitored quantities. The reconfiguring of the OTT connection 2016 may include message format, retransmission settings, preferred routing, etc.; the reconfiguring need not affect the base station 2018, and it may be unknown or imperceptible to the base station 2018. Such procedures and functionalities may be known and practiced in the art. In certain embodiments, measurements may involve proprietary UE signaling facilitating the host computer 2002's measurements of throughput, propagation times, latency, and the like. The measurements may be implemented in that the software 2010 and 2040 causes messages to be transmitted, in particular empty or ‘dummy’ messages, using the OTT connection 2016 while it monitors propagation times, errors, etc.

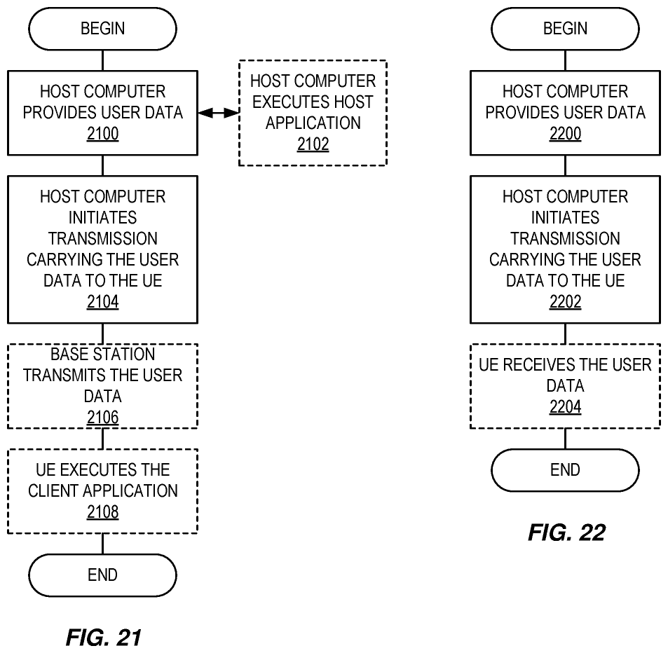

FIG. 21 is a flowchart illustrating a method implemented in a communication system, in accordance with one embodiment. The communication system includes a host computer, a base station, and a UE which may be those described with reference to FIGS. 19 and 20. For simplicity of the present disclosure, only drawing references to FIG. 21 will be included in this section. In step 2100, the host computer provides user data. In sub-step 2102 (which may be optional) of step 2100, the host computer provides the user data by executing a host application. In step 2104, the host computer initiates a transmission carrying the user data to the UE. In step 2106 (which may be optional), the base station transmits to the UE the user data which was carried in the transmission that the host computer initiated, in accordance with the teachings of the embodiments described throughout this disclosure. In step 2108 (which may also be optional), the UE executes a client application associated with the host application executed by the host computer.

FIG. 22 is a flowchart illustrating a method implemented in a communication system, in accordance with one embodiment. The communication system includes a host computer, a base station, and a UE which may be those described with reference to FIGS. 19 and 20. For simplicity of the present disclosure, only drawing references to FIG. 22 will be included in this section. In step 2200 of the method, the host computer provides user data. In an optional sub-step (not shown) the host computer provides the user data by executing a host application. In step 2202, the host computer initiates a transmission carrying the user data to the UE. The transmission may pass via the base station, in accordance with the teachings of the embodiments described throughout this disclosure. In step 2204 (which may be optional), the UE receives the user data carried in the transmission.

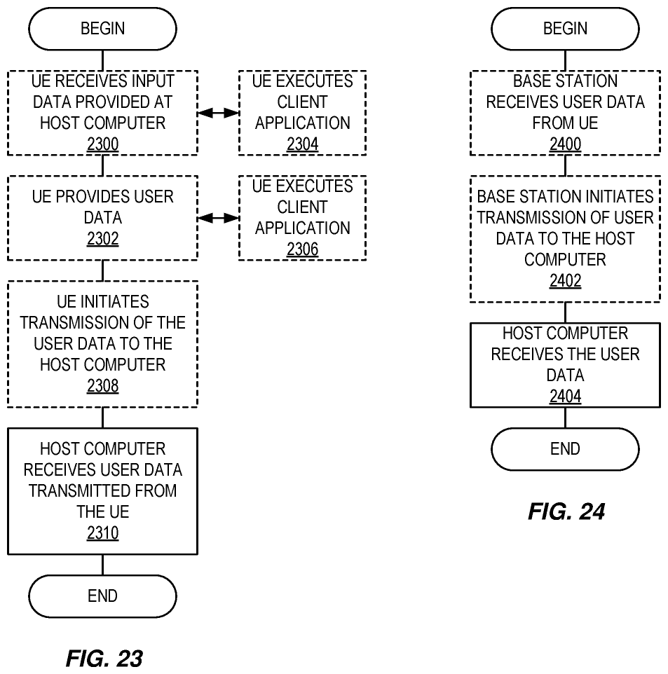

FIG. 23 is a flowchart illustrating a method implemented in a communication system, in accordance with one embodiment. The communication system includes a host computer, a base station, and a UE which may be those described with reference to FIGS. 19 and 20. For simplicity of the present disclosure, only drawing references to FIG. 23 will be included in this section. In step 2300 (which may be optional), the UE receives input data provided by the host computer. Additionally or alternatively, in step 2302, the UE provides user data. In sub-step 2304 (which may be optional) of step 2300, the UE provides the user data by executing a client application. In sub-step 2306 (which may be optional) of step 2302, the UE executes a client application which provides the user data in reaction to the received input data provided by the host computer. In providing the user data, the executed client application may further consider user input received from the user. Regardless of the specific manner in which the user data was provided, the UE initiates, in sub-step 2308 (which may be optional), transmission of the user data to the host computer. In step 2310 of the method, the host computer receives the user data transmitted from the UE, in accordance with the teachings of the embodiments described throughout this disclosure.

FIG. 24 is a flowchart illustrating a method implemented in a communication system, in accordance with one embodiment. The communication system includes a host computer, a base station, and a UE which may be those described with reference to FIGS. 19 and 20. For simplicity of the present disclosure, only drawing references to FIG. 24 will be included in this section. In step 2400 (which may be optional), in accordance with the teachings of the embodiments described throughout this disclosure, the base station receives user data from the UE. In step 2402 (which may be optional), the base station initiates transmission of the received user data to the host computer. In step 2404 (which may be optional), the host computer receives the user data carried in the transmission initiated by the base station.

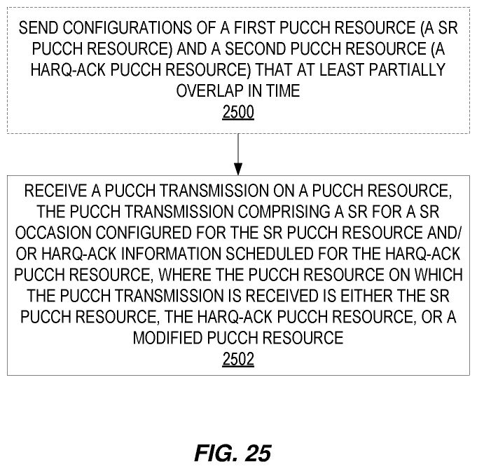

FIG. 25 is a flow chart that illustrates the operation of a base station 102 in accordance with at least some of the embodiments described herein (e.g., in Sections 1, 2, and/or 3 above). Optional steps are represented by dashed lines/boxes. As illustrated, the base station 102 sends, to a wireless communication device 112, a configuration of a first PUCCH resource for a SR occasion (referred to herein as a SR PUCCH resource) and a second PUCCH resource for HARQ-ACK information (referred to herein as HARQ-ACK PUCCH resource) (step 2500). As described above, the SR PUCCH resource and the HARQ-ACK PUCCH resource at least partially overlap in time. The base station 102 receives a PUCCH transmission from the wireless device 112 on a PUCCH resource, where the PUCCH transmission includes either a SR for the SR occasion for which the SR PUCCH resource is configured, HARQ-ACK information scheduled for the HARQ-ACK PUCCH resource, or both. For this PUCCH transmission, any embodiment of the prioritization or multiplexing of SR and HARQ-ACK information described above (e.g., in Section 1, 2, or 3) is used. As such, the details above regarding these embodiments as they pertain to the operation of the base station 102 are equally applicable here.

Any appropriate steps, methods, features, functions, or benefits disclosed herein may be performed through one or more functional units or modules of one or more virtual apparatuses. Each virtual apparatus may comprise a number of these functional units. These functional units may be implemented via processing circuitry, which may include one or more microprocessor or microcontrollers, as well as other digital hardware, which may include Digital Signal Processor (DSPs), special-purpose digital logic, and the like. The processing circuitry may be configured to execute program code stored in memory, which may include one or several types of memory such as Read Only Memory (ROM), Random Access Memory (RAM), cache memory, flash memory devices, optical storage devices, etc. Program code stored in memory includes program instructions for executing one or more telecommunications and/or data communications protocols as well as instructions for carrying out one or more of the techniques described herein. In some implementations, the processing circuitry may be used to cause the respective functional unit to perform corresponding functions according one or more embodiments of the present disclosure.

While processes in the figures may show a particular order of operations performed by certain embodiments of the present disclosure, it should be understood that such order is exemplary (e.g., alternative embodiments may perform the operations in a different order, combine certain operations, overlap certain operations, etc.).

Some example embodiments of the present disclosure are as follows:

### GROUP A EMBODIMENTS

Embodiment 1: A method performed by a wireless communication device (112) for prioritization between a Scheduling Request, SR, occasion and Hybrid Automatic Repeat Request Acknowledgment, HARQ-ACK, bits scheduled on overlapping Physical Uplink Control Channel, PUCCH, resources, the method comprising: prioritizing or multiplexing (202; 302; 402; 1302) a SR occasion (e.g., using PUCCH format 0) on a first PUCCH resource and HARQ-ACK information (e.g., using PUCCH format 1) on a second PUCCH resource, the first PUCCH resource and the second PUCCH resource at least partially overlapping in time.

Embodiment 2: The method of embodiment 1 wherein the SR occasion uses PUCCH format 0, and the HARQ-ACK information uses PUCCH format 1.

Embodiment 3: The method of embodiment 1 or 2 wherein prioritizing or multiplexing (202; 302; 1302) the SR occasion on the first PUCCH resource and the HARQ-ACK information on the second PUCCH resource comprises:
determining (202A; 302A) that a SR for the SR occasion is a negative SR; and
   responsive to determining (202A; 302A) that the SR for the SR occasion is a negative SR:
      dropping (204A) the SR occasion; and
      transmitting (204B) one or more HARQ-ACK bits on the second PUCCH resource using PUCCH format 1.

Embodiment 4: The method of embodiment 1 or 2 wherein prioritizing or multiplexing (202; 302; 1302) the SR occasion on the first PUCCH resource and the HARQ-ACK information on the second PUCCH resource comprises:
determining (202A) that a SR for the SR occasion is not a negative SR; and
responsive to determining (202A) that the SR for the SR occasion is not a negative SR:
   determining (202B) whether one or more HARQ-ACK bits to be transmitted satisfy one or more conditions;
   responsive to determining (202B, YES) that the one or more HARQ-ACK bits to be transmitted satisfy the one or more conditions:
      dropping (204C) the one or more HARQ-ACK bits; and
      transmitting (204D) the SR on the first PUCCH resource using PUCCH format 0.

Embodiment 5: The method of embodiment 4 wherein, responsive to determining (202B, NO) that the one or more HARQ-ACK bits to be transmitted do not satisfy the one or more conditions: dropping (204A) the SR occasion; and transmitting (204B) one or more HARQ-ACK bits on the second PUCCH resource using PUCCH format 1.

Embodiment 6: The method of embodiment 4 or 5 wherein the one or more conditions comprise: a condition that the one or more HARQ-ACK bits indicates all ACK; a condition that the one or more HARQ-ACK bits indicates all NACK; a condition that at least one of the one or more HARQ-ACK bits indicates ACK; or a condition that at least one of the HARQ-ACK bits indicates NACK.

Embodiment 7: The method of embodiment 1 or 2 wherein prioritizing or multiplexing (202; 302; 1302) the SR occasion on the first PUCCH resource and the HARQ-ACK information on the second PUCCH resource comprises:
determining (202A) that a SR for the SR occasion is not a negative SR; and
responsive to determining (202A) that the SR for the SR occasion is not a negative SR:
   dropping (204C) the one or more HARQ-ACK bits; and
   transmitting (204D) the SR on the first PUCCH resource using PUCCH format 0.

Embodiment 8: The method of embodiment 1 or 2 wherein prioritizing or multiplexing (202; 302; 1302) the SR occasion on the first PUCCH resource and the HARQ-ACK information on the second PUCCH resource comprises:
determining (302A) that a SR for the SR occasion is not a negative SR; and
responsive to determining (302A) that the SR for the SR occasion is not a negative SR:
   dropping (304C) the SR occasion; and
   transmitting (304D) one or more HARQ-ACK bits on the second PUCCH resource using PUCCH format 1, while using a cyclic shift that is different from an initially scheduled cyclic shift.

Embodiment 9: The method of embodiment 1 or 2 wherein prioritizing or multiplexing (202; 302; 402; 1302) the SR occasion on the first PUCCH resource and the HARQ-ACK information on the second PUCCH resource comprises multiplexing (402) the SR and one or more HARQ-ACK bits on the first PUCCH resource by using a cyclic shift for a sequence used for the SR, the cyclic shift being a function of the one or more HARQ-ACK bits.

Embodiment 10: The method of embodiment 1 or 2 wherein prioritizing or multiplexing (202; 302; 1302) the SR occasion on the first PUCCH resource and the HARQ-ACK information on the second PUCCH resource comprises: multiplexing (1302) a SR and one or more HARQ-ACK bits on one of the first PUCCH resource, the second PUCCH resource, or a modified PUCCH resource.

Embodiment 11: The method of embodiment 10 wherein multiplexing (1302) the SR and the one or more HARQ-ACK bits on the second PUCCH resource by appending (1302A) information that indicates the SR (e.g., a first bit) to HARQ-feedback information (e.g., a second bit) that serves as an indication of the one or more HARQ-ACK bits.

Embodiment 12: The method of embodiment 10 wherein multiplexing (1302) the SR and the one or more HARQ-ACK bits comprises multiplexing the SR and the one or more HARQ-ACK bits on the second PUCCH resource using a cyclic shift.

Embodiment 13: The method of embodiment 10 wherein multiplexing (1302) the SR and the one or more HARQ-ACK bits comprises multiplexing the SR and the one or more HARQ-ACK bits on a modified PUCCH resource.

Embodiment 14: The method of any of the previous embodiments, further comprising: providing user data; and forwarding the user data to a host computer via the transmission to the base station.

### Group B Embodiments

Embodiment 15: A method performed by a base station for prioritization between a Scheduling Request, SR, occasion and Hybrid Automatic Repeat Request Acknowledgment, HARQ-ACK, bits scheduled on overlapping Physical Uplink Control Channel, PUCCH, resources, the method comprising: receiving uplink control information on a PUCCH resource, the UCI comprising a SR, one or more HARQ-ACK bits, or information that represents both the SR and the one or more HARQ-ACK bits, in accordance with a prioritization or multiplexing scheme; wherein the PUCCH resource is either: (a) a first PUCCH resource scheduled or configured for the SR, (b) a second PUCCH resource scheduled or configured for the one or more HARQ-ACK bits, or (c) a modified PUCCH resource; wherein the first PUCCH resource and the second PUCCH resource at least partially overlap in time.

Embodiment 16: The method of any of the previous embodiments, further comprising: obtaining user data; and forwarding the user data to a host computer or a wireless communication device.

### Group C Embodiments

Embodiment 17: A wireless communication device comprising: processing circuitry configured to perform any of the steps of any of the Group A embodiments; and power supply circuitry configured to supply power to the wireless communication device.

Embodiment 18: A base station comprising: processing circuitry configured to perform any of the steps of any of the Group B embodiments; and power supply circuitry configured to supply power to the base station.

Embodiment 19: A User Equipment, UE, comprising: an antenna configured to send and receive wireless signals; radio front-end circuitry connected to the antenna and to processing circuitry, and configured to condition signals communicated between the antenna and the processing circuitry; the processing circuitry being configured to perform any of the steps of any of the Group A embodiments; an input interface connected to the processing circuitry and configured to allow input of information into the UE to be processed by the processing circuitry; an output interface connected to the processing circuitry and configured to output information from the UE that has been processed by the processing circuitry; and a battery connected to the processing circuitry and configured to supply power to the UE.

Embodiment 20: A communication system including a host computer comprising: processing circuitry configured to provide user data; and a communication interface configured to forward the user data to a cellular network for transmission to a User Equipment, UE; wherein the cellular network comprises a base station having a radio interface and processing circuitry, the base station's processing circuitry configured to perform any of the steps of any of the Group B embodiments.

Embodiment 21: The communication system of the previous embodiment further including the base station.

Embodiment 22: The communication system of the previous 2 embodiments, further including the UE, wherein the UE is configured to communicate with the base station.

Embodiment 23: The communication system of the previous 3 embodiments, wherein: the processing circuitry of the host computer is configured to execute a host application, thereby providing the user data; and the UE comprises processing circuitry configured to execute a client application associated with the host application.

Embodiment 24: A method implemented in a communication system including a host computer, a base station, and a User Equipment, UE, the method comprising: at the host computer, providing user data; and at the host computer, initiating a transmission carrying the user data to the UE via a cellular network comprising the base station, wherein the base station performs any of the steps of any of the Group B embodiments.

Embodiment 25: The method of the previous embodiment, further comprising, at the base station, transmitting the user data.

Embodiment 26: The method of the previous 2 embodiments, wherein the user data is provided at the host computer by executing a host application, the method further comprising, at the UE, executing a client application associated with the host application.

Embodiment 27: A User Equipment, UE, configured to communicate with a base station, the UE comprising a radio interface and processing circuitry configured to perform the method of the previous 3 embodiments.

Embodiment 28: A communication system including a host computer comprising: processing circuitry configured to provide user data; and a communication interface configured to forward user data to a cellular network for transmission to a User Equipment, UE; wherein the UE comprises a radio interface and processing circuitry, the UE's components configured to perform any of the steps of any of the Group A embodiments.

Embodiment 29: The communication system of the previous embodiment, wherein the cellular network further includes a base station configured to communicate with the UE.

Embodiment 30: The communication system of the previous 2 embodiments, wherein: the processing circuitry of the host computer is configured to execute a host application, thereby providing the user data; and the UE's processing circuitry is configured to execute a client application associated with the host application.

Embodiment 31: A method implemented in a communication system including a host computer, a base station, and a User Equipment, UE, the method comprising: at the host computer, providing user data; and at the host computer, initiating a transmission carrying the user data to the UE via a cellular network comprising the base station, wherein the UE performs any of the steps of any of the Group A embodiments.

Embodiment 32: The method of the previous embodiment, further comprising at the UE, receiving the user data from the base station.

Embodiment 33: A communication system including a host computer comprising: communication interface configured to receive user data originating from a transmission from a User Equipment, UE, to a base station; wherein the UE comprises a radio interface and processing circuitry, the UE's processing circuitry configured to perform any of the steps of any of the Group A embodiments.

Embodiment 34: The communication system of the previous embodiment, further including the UE.

Embodiment 35: The communication system of the previous 2 embodiments, further including the base station, wherein the base station comprises a radio interface configured to communicate with the UE and a communication interface configured to forward to the host computer the user data carried by a transmission from the UE to the base station.

Embodiment 36: The communication system of the previous 3 embodiments, wherein: the processing circuitry of the host computer is configured to execute a host application; and the UE's processing circuitry is configured to execute a client application associated with the host application, thereby providing the user data.

Embodiment 37: The communication system of the previous 4 embodiments, wherein: the processing circuitry of the host computer is configured to execute a host application, thereby providing request data; and the UE's processing circuitry is configured to execute a client application associated with the host application, thereby providing the user data in response to the request data.

Embodiment 38: A method implemented in a communication system including a host computer, a base station, and a User Equipment, UE, the method comprising: at the host computer, receiving user data transmitted to the base station from the UE, wherein the UE performs any of the steps of any of the Group A embodiments.

Embodiment 39: The method of the previous embodiment, further comprising, at the UE, providing the user data to the base station.

Embodiment 40: The method of the previous 2 embodiments, further comprising: at the UE, executing a client application, thereby providing the user data to be transmitted; and at the host computer, executing a host application associated with the client application.

Embodiment 41: The method of the previous 3 embodiments, further comprising: at the UE, executing a client application; and at the UE, receiving input data to the client application, the input data being provided at the host computer by executing a host application associated with the client application; wherein the user data to be transmitted is provided by the client application in response to the input data.

Embodiment 42: A communication system including a host computer comprising a communication interface configured to receive user data originating from a transmission from a User Equipment, UE, to a base station, wherein the base station comprises a radio interface and processing circuitry, the base station's processing circuitry configured to perform any of the steps of any of the Group B embodiments.

Embodiment 43: The communication system of the previous embodiment further including the base station.

Embodiment 44: The communication system of the previous 2 embodiments, further including the UE, wherein the UE is configured to communicate with the base station.

Embodiment 45: The communication system of the previous 3 embodiments, wherein: the processing circuitry of the host computer is configured to execute a host application; and the UE is configured to execute a client application associated with the host application, thereby providing the user data to be received by the host computer.

Embodiment 46: A method implemented in a communication system including a host computer, a base station, and a User Equipment, UE, the method comprising: at the host computer, receiving, from the base station, user data originating from a transmission which the base station has received from the UE, wherein the UE performs any of the steps of any of the Group A embodiments.

Embodiment 47: The method of the previous embodiment, further comprising at the base station, receiving the user data from the UE.

Embodiment 48: The method of the previous 2 embodiments, further comprising at the base station, initiating a transmission of the received user data to the host computer.

Those skilled in the art will recognize improvements and modifications to the embodiments of the present disclosure. All such improvements and modifications are considered within the scope of the concepts disclosed herein.

1. A method performed by a wireless communication device for prioritization between a Scheduling Request (SR) occasion and Hybrid Automatic Repeat Request Acknowledgment (HARQ-ACK) information scheduled on overlapping Physical Uplink Control Channel, PUCCH, resources, the method comprising:
prioritizing or multiplexing a SR occasion on a first PUCCH resource and HARQ-ACK information on a second PUCCH resource, the first PUCCH resource and the second PUCCH resource at least partially overlapping in time.

2. The method of claim 1 wherein prioritizing or multiplexing the SR occasion on the first PUCCH resource and the HARQ-ACK information on the second PUCCH resource comprises prioritizing or multiplexing the SR occasion on the first PUCCH resource and the HARQ-ACK information on the second PUCCH resource based on a priority of the SR and a priority of the HARQ-ACK information.

3. The method of claim 1 wherein the SR occasion uses PUCCH format 0, and the HARQ-ACK information uses PUCCH format 1.

4. The method of claim 1 wherein prioritizing or multiplexing the SR occasion on the first PUCCH resource and the HARQ-ACK information on the second PUCCH resource comprises:
determining that a SR for the SR occasion is a negative SR; and
responsive to determining that the SR for the SR occasion is a negative SR:
dropping the SR occasion; and
transmitting one or more HARQ-ACK bits on the second PUCCH resource using PUCCH format 1.

5. The method of claim 1 wherein prioritizing or multiplexing the SR occasion on the first PUCCH resource and the HARQ-ACK information on the second PUCCH resource comprises:
determining that a SR for the SR occasion is not a negative SR; and
determining whether one or more HARQ-ACK bits to be transmitted satisfy one or more conditions;
responsive to determining that the SR for the SR occasion is not a negative SR and determining that the one or more HARQ-ACK bits to be transmitted satisfy the one or more conditions:
dropping the one or more HARQ-ACK bits; and
transmitting the SR on the first PUCCH resource using PUCCH format 0.

6. The method of claim 5 wherein prioritizing or multiplexing the SR occasion on the first PUCCH resource and the HARQ-ACK information on the second PUCCH resource further comprises, responsive to determining that the SR for the SR occasion is not a negative SR and determining that the one or more HARQ-ACK bits to be transmitted do not satisfy the one or more conditions,
dropping the SR occasion; and
transmitting one or more HARQ-ACK bits on the second PUCCH resource using PUCCH format 1.

7. The method of claim 5 wherein the one or more conditions comprise:
a condition that the one or more HARQ-ACK bits indicates all ACK;
a condition that the one or more HARQ-ACK bits indicates all NACK;
a condition that at least one of the one or more HARQ-ACK bits indicates ACK; or
a condition that at least one of the HARQ-ACK bits indicates NACK.

8. The method of claim 1 wherein prioritizing or multiplexing the SR occasion on the first PUCCH resource and the HARQ-ACK information on the second PUCCH resource comprises:
determining that a SR for the SR occasion is not a negative SR; and
responsive to determining that the SR for the SR occasion is not a negative SR:
dropping the one or more HARQ-ACK bits; and
transmitting the SR on the first PUCCH resource using PUCCH format 0.

9. The method of claim 1 wherein prioritizing or multiplexing the SR occasion on the first PUCCH resource and the HARQ-ACK information on the second PUCCH resource comprises:
determining that a SR for the SR occasion is not a negative SR; and
responsive to determining that the SR for the SR occasion is not a negative SR:
dropping the SR occasion; and
transmitting one or more HARQ-ACK bits on the second PUCCH resource using PUCCH format 1, while using a cyclic shift that is different from an initially scheduled cyclic shift.

10. The method of claim 1 wherein prioritizing or multiplexing the SR occasion on the first PUCCH resource and the HARQ-ACK information on the second PUCCH resource comprises multiplexing the SR and one or more HARQ-ACK bits on the first PUCCH resource by using a cyclic shift for a sequence used for the SR, the cyclic shift being a function of the one or more HARQ-ACK bits.

11. The method of claim 1 wherein prioritizing or multiplexing the SR occasion on the first PUCCH resource and the HARQ-ACK information on the second PUCCH resource comprises:
multiplexing a SR and one or more HARQ-ACK bits on one of the first PUCCH resource, the second PUCCH resource, or a modified PUCCH resource.

12. The method of claim 11 wherein multiplexing the SR and the one or more HARQ-ACK bits on the second PUCCH resource comprises:
transmitting a PUCCH on the one of the first PUCCH resource, the second PUCCH resource, or a modified PUCCH resource;
wherein the PUCCH comprises the HARQ-ACK information and the information that indicates the SR that is appended to the HARQ ACK information.

13. The method of claim 11 wherein multiplexing the SR and the one or more HARQ-ACK bits on the second PUCCH resource by appending information that indicates the SR to HARQ-ACK information that serves as an indication of the one or more HARQ-ACK bits.

14. The method of claim 11 wherein the one or more HARQ-ACK bits are two or more HARQ-ACK bits, and multiplexing the SR and the one or more HARQ-ACK bits on the second PUCCH resource by appending information that indicates the SR to HARQ-ACK information, wherein the HARQ-ACK information comprises a single bit that serves as an indication of the two or more HARQ-ACK bits in accordance with a predefined rule.

15. (canceled)

16. The method of claim 11 wherein multiplexing the SR and the one or more HARQ-ACK bits comprises multiplexing the SR and the one or more HARQ-ACK bits on the second PUCCH resource by using a cyclic shift of a sequence transmitted on the second PUCCH resource to indicate whether the SR is a positive SR or a negative SR.

17. The method of claim 11 wherein multiplexing the SR and the one or more HARQ-ACK bits comprises multiplexing the SR and the one or more HARQ-ACK bits using a modified PUCCH resource.

18-29. (canceled)

30. A wireless communication device for prioritization between a Scheduling Request (SR) occasion and Hybrid Automatic Repeat Request Acknowledgment (HARQ-ACK) information scheduled on overlapping Physical Uplink Control Channel resources, the wireless communication device comprising:
one or more transmitters;
one or more receivers; and
processing circuitry associated with the one or more transmitters and the one or more receivers, the processing circuitry configured to cause the wireless communication device to:
prioritize or multiplex a SR occasion on a first PUCCH resource and HARQ-ACK information on a second PUCCH resource, the first PUCCH resource and the second PUCCH resource at least partially overlapping in time.

31. (canceled)

32. A method performed by a base station for prioritization between a Scheduling Request (SR) occasion and Hybrid Automatic Repeat Request Acknowledgment information scheduled on overlapping Physical Uplink Control Channel resources, the method comprising:
receiving a PUCCH transmission on a PUCCH resource, the PUCCH transmission comprising a SR for a SR occasion configured on a first PUCCH resource, HARQ-ACK information scheduled on a second PUCCH resource, or information that represents both the SR and the HARQ-ACK information, in accordance with a prioritization or multiplexing scheme;
wherein the PUCCH resource is either: (a) the first PUCCH resource configured for the SR occasion, (b) the second PUCCH resource configured for the HARQ-ACK information, or (c) a modified PUCCH resource;
wherein the first PUCCH resource and the second PUCCH resource at least partially overlap in time.

33. The method of claim 32 wherein the SR occasion uses PUCCH format 0, and the HARQ-ACK information uses PUCCH format 1.

34. The method of claim 32 wherein the SR is a negative SR, the PUCCH resource is the second PUCCH resource, and receiving the PUCCH transmission comprises receiving one or more HARQ-ACK bits on the second PUCCH resource using PUCCH format 1.

35. The method of claim 32 wherein the SR is a positive SR, the one or more HARQ bits satisfy one or more conditions, the PUCCH resource is the first PUCCH resource, receiving the PUCCH transmission comprises receiving the SR on the first PUCCH resource using PUCCH format 0, and the HARQ-ACK information is dropped.

36. The method of claim 32 wherein the SR is a positive SR, the one or more HARQ bits do not satisfy one or more conditions, the PUCCH resource is the second PUCCH resource, receiving the PUCCH transmission comprises receiving the one or more HARQ-ACK bits on the second PUCCH resource using PUCCH format 1, and the SR is dropped.

37. (canceled)

38. The method of claim 32 wherein the SR is a positive SR, the PUCCH resource is the first PUCCH resource, receiving the PUCCH transmission comprises receiving the SR on the first PUCCH resource using PUCCH format 0, and the HARQ-ACK information is dropped.

39. The method of claim 32 wherein the SR is a positive SR, the PUCCH resource is the second PUCCH resource, receiving the PUCCH transmission comprises receiving the HARQ-ACK information on the second PUCCH resource using PUCCH format 1 while using a cyclic shift that is different from an initially scheduled cyclic shift, and the SR occasion is dropped.

40-49. (canceled)
